(19) United States
(12) Patent Application Publication
(10) Pub. No.: US 2025/0100142 A1
(43) Pub. Date: Mar. 27, 2025

(54) PATH GENERATION DEVICE

(71) Applicant: Mitsubishi Electric Corporation, Tokyo (JP)

(72) Inventors: Kiyoshi MAEKAWA, Tokyo (JP); Satoru MATSUOKA, Tokyo (JP)

(73) Assignee: Mitsubishi Electric Corporation, Tokyo (JP)

(21) Appl. No.: 18/832,138

(22) PCT Filed: Jan. 25, 2023
(86) PCT No.: PCT/JP2023/002235

§ 371 Date: Jul. 23, 2024

(30) Foreign Application Priority Data
Feb. 4, 2022 (JP) 2022-016096

(51) Int. Cl. B25J 9/16

(52) U.S. Cl. CPC B25J 9/1664; B25J 9/1651; B25J 9/1653

(57) ABSTRACT

A path generation device includes maximum displacement axis calculation means that calculates a maximum displacement axis among multiple axes, where the maximum displacement axis has a highest ratio of a displacement distance relative to a maximum speed in a motion from a motion start point to a motion end point; initial passing point calculation means that generates passing points to be used when the multiple axes move in synchronization with one another; interference area extraction means that extracts a section including a passing point on which interference with a surrounding object will occur, among multiple passing points generated by the initial passing point calculation means; and non-maximum displacement axis modification means that generates a passing point that leads to avoidance of interference, by modifying a position of a non-maximum displacement axis, which is, among the multiple axes, an axis other than the maximum displacement axis calculated.

### FIELD

The present disclosure relates to a path generation device for generating a target path of an industrial machine that prevents interference with a surrounding object on the basis of information about the start point and the end point of a motion and information about surrounding environments, in relation to an industrial machine such as a robot or a machine tool.

### BACKGROUND

In an assembly work in electrical and electronics industry, in a work of dismounting from a machine tool, or in a delivery operation in food industry or logistics industry, a robot needs to be operated to prevent interference with an obstacle inside the system when a task is performed using the robot. Increasing the speed of robot operation while preventing an interference requires a high level of skill in generation and adjustment of a program. A technology is thus desired that enables even an unexperienced person to easily generate a program for operating a robot while avoiding an obstacle.

A path generation method has conventionally been suggested that generates a path along which a robot arm is to be moved between a suggested start point and a suggested target point (see, e.g., Patent Literature 1). The conventional path generation method includes a suggested-intermediate-point generation step, in which a control device displaces a first suggested intermediate point group placed between a suggested start point and a suggested target point of a path of robot arm movement to generate a second suggested intermediate point group; and a path generation step, in which the control device generates a path along which a robot arm model simulating the robot arm is to be moved, on the basis of the second suggested intermediate point group. The conventional path generation method further includes an evaluation step, in which the control device generates evaluation values with respect to multiple paths generated, in the path generation step, from multiple respective second suggested intermediate point groups that have been generated in the suggested-intermediate-point generation step by displacing the first suggested intermediate point group by different amounts of displacement. The conventional path generation method still further includes a path determination step, in which the control device moves the first suggested intermediate point group on the basis of the evaluation values with respect to the multiple paths generated in the evaluation step, repeatedly performs the suggested-intermediate-point generation step, the path generation step, and the evaluation step on the first suggested intermediate point group that has been moved, and determines that a first suggested intermediate point group satisfying a predetermined condition is a suggested intermediate point group for use in generation of the path along which the robot arm is to be moved. In the suggested-intermediate-point generation step for generating the second suggested intermediate point group, a random number value is added as a parameter for providing a spatial displacement.

### CITATION LIST

### Patent Literature

Patent Literature 1: Japanese Patent Application Laid-open No. 2019-135076

### SUMMARY OF INVENTION

### Problem to be Solved by the Invention

The conventional technology has a problem in that an optimum path is not necessarily obtainable because the passing points are modified by generating a random number upon generation of passing points that are a suggested intermediate point group on a path that leads to avoidance of interference; a problem in that a relatively long time is required to determine the passing points due to necessity of repeated modification of the passing points to obtain a path that will reduce the motion time; and a problem in that the generated path varies from trial to trial.

The present disclosure has been made in view of the foregoing, and it is an object of the present disclosure to provide a path generation device capable of generating an optimum path that will reduce the motion time while avoiding interference, capable of searching for a target path in a relatively short time, and capable of reducing a variation across trials.

### Means to Solve the Problem

In order to solve the above-described problems and achieve the object, a path generation device according to the present disclosure includes: maximum displacement axis calculation means that calculates a maximum displacement axis among a plurality of axes, the maximum displacement axis having a highest ratio of a displacement distance relative to a maximum speed in a motion from a motion start point to a motion end point; initial passing point calculation means that generates passing points to be used when the plurality of axes move in synchronization with one another; interference area extraction means that extracts a section including a passing point on which interference with a surrounding object will occur, among the plurality of passing points generated by the initial passing point calculation means; and non-maximum displacement axis modification means that generates a passing point that leads to avoidance of interference, by modifying a position of a non-maximum displacement axis, the non-maximum displacement axis being, among the plurality of axes, an axis other than the maximum displacement axis calculated by the maximum displacement axis calculation means. The path generation device according to the present disclosure uses an output of the non-maximum displacement axis modification means as a target path.

### Effects of the Invention

A path generation device according to the present disclosure provides advantages in capability of generating an optimum path that will reduce the motion time while avoiding interference, capability of searching for a target path in a relatively short time, and capability of reducing a variation across trials.

### BRIEF DESCRIPTION OF DRAWINGS

FIG. 1 is a diagram illustrating a configuration of a path generation device according to a first embodiment.

FIG. 2 is a diagram illustrating a first example of modification on the amount of displacement between passing points in the first embodiment.

FIG. 3 is a diagram illustrating a configuration of non-maximum displacement axis modification means included in the path generation device according to the first embodiment.

FIG. 4 is a diagram illustrating a second example of modification on the amount of displacement between passing points performed in the first embodiment.

FIG. 5 is a diagram illustrating a third example of modification on the amount of displacement between passing points performed in the first embodiment.

FIG. 6 is an illustrative diagram of positional changes of passing points provided in the case of modification of FIG. 2.

FIG. 7 is a diagram illustrating a fourth example of modification on the amount of displacement between passing points performed in the first embodiment.

FIG. 8 is a diagram illustrating a fifth example of modification on the amount of displacement between passing points performed in the first embodiment.

FIG. 9 is a diagram illustrating a configuration of the non-maximum displacement axis modification means included in the path generation device according to a second embodiment.

FIG. 10 is a diagram illustrating an example of modification on the amount of displacement between passing points performed in the second embodiment.

FIG. 11 is a diagram illustrating a configuration of the non-maximum displacement axis modification means included in the path generation device according to a third embodiment.

FIG. 12 is a diagram illustrating a configuration of the non-maximum displacement axis modification means included in the path generation device according to a fourth embodiment.

FIG. 13 is a diagram illustrating a configuration of the non-maximum displacement axis modification means included in the path generation device according to a fifth embodiment.

FIG. 14 is a diagram illustrating a configuration of the non-maximum displacement axis modification means included in the path generation device according to a sixth embodiment.

FIG. 15 is a diagram illustrating a configuration of a path generation device according to a seventh embodiment.

FIG. 16 is a diagram illustrating a configuration of a path generation device according to an eighth embodiment.

FIG. 17 is a diagram illustrating a configuration of a path generation device according to a ninth embodiment.

FIG. 18 is a diagram illustrating a configuration of a path generation device according to a tenth embodiment.

FIG. 19 is a diagram illustrating the amount of displacement of passing points in a twelfth embodiment.

FIG. 20 is a diagram illustrating a configuration of a path generation device according to a thirteenth embodiment.

FIG. 21 is a diagram for describing an example of modification on non-maximum displacement axes while maintaining the hand end posture, using a schematic diagram of a vertical articulated robot having six rotational axes.

FIG. 22 is a diagram illustrating a configuration of a path generation device according to a fourteenth embodiment.

FIG. 23 is a diagram illustrating an example of modification on acceleration and deceleration performed by command modification means included in the path generation device according to the fourteenth embodiment.

FIG. 24 is a diagram illustrating a configuration of a path generation device according to a fifteenth embodiment.

FIG. 25 is a diagram illustrating a configuration of a path generation device according to a sixteenth embodiment.

FIG. 26 is a diagram for describing an example of operation of the path generation device according to the sixteenth embodiment.

FIG. 27 is a diagram illustrating a processor when at least part of functionality of maximum displacement axis calculation means, initial passing point calculation means, interference area extraction means, and the non-maximum displacement axis modification means included in the path generation device according to the first embodiment is implemented in the processor.

FIG. 28 is a diagram illustrating a processing circuitry when at least part of the maximum displacement axis calculation means, the initial passing point calculation means, the interference area extraction means, and the non-maximum displacement axis modification means included in the path generation device according to the first embodiment are implemented in the processing circuitry.

### DESCRIPTION OF EMBODIMENTS

A path generation device according to embodiments will be described in detail below with reference to the drawings.

### First Embodiment

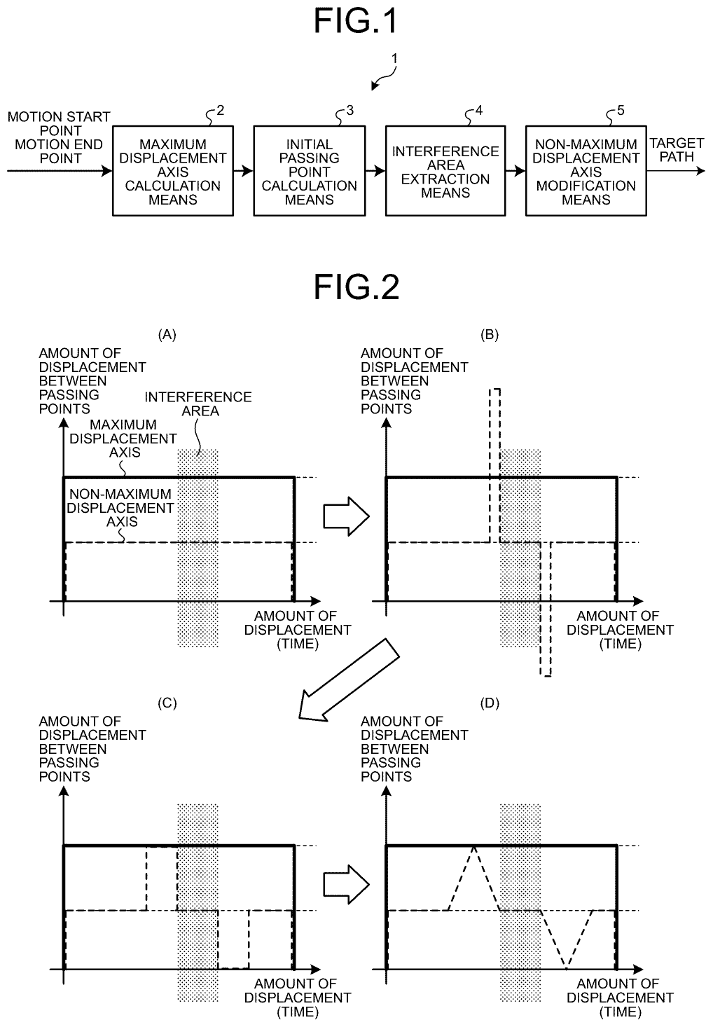

FIG. 1 is a diagram illustrating a configuration of a path generation device 1 according to a first embodiment. The path generation device 1 is a device for use in path generation of an industrial machine such as an industrial robot, a human-collaborating robot, or a machine tool. The path generation device 1 may be disposed inside a control device of machinery such as an industrial robot or may be included in a personal computer or in a cloud outside the control device. The path generation device 1 receives information about a motion start point and information about a motion end point.

The path generation device 1 includes maximum displacement axis calculation means 2 and initial passing point calculation means 3. The maximum displacement axis calculation means 2 calculates a maximum displacement axis, which has a highest ratio of a displacement distance relative to a maximum speed in a motion from the motion start point to the motion end point, among multiple axes of a control target. The initial passing point calculation means 3 generates passing points to be used when multiple axes move in synchronization with one another. The path generation device 1 further includes interference area extraction means 4 and non-maximum displacement axis modification means 5. The interference area extraction means 4 extracts a section including a passing point on which interference with a surrounding object will occur, among the multiple passing points generated by the initial passing point calculation means 3. The non-maximum displacement axis modification means 5 generates a passing point that leads to avoidance of interference, by modifying the position of a non-maximum displacement axis, which is, among the multiple axes, an axis other than the maximum displacement axis calculated by the maximum displacement axis calculation means 2. The path generation device 1 uses an output of the non-maximum displacement axis modification means 5 as a target path. The maximum displacement axis calculation means 2, the initial passing point calculation means 3, the interference area extraction means 4, and the non-maximum displacement axis modification means 5 are each described in more detail below.

The maximum displacement axis calculation means 2 calculates which axis will be the maximum displacement axis in a specified motion on the basis of the information about the motion start point and the information about the motion end point that have been input, and on the basis of an internally stored maximum speed of each of the multiple axes of the control target such as an industrial robot. Specifically, for each of the multiple axes of the control target, the maximum displacement axis calculation means 2 subtracts the position of the motion start point from the position of the motion end point, and divides the result obtained by subtraction, by the maximum speed of that axis. The maximum displacement axis calculation means 2 then selects the axis having a largest absolute value among the absolute values of the results obtained by division, as the maximum displacement axis. Among the multiple axes, an axis other than the maximum displacement axis is designated non-maximum displacement axis. When more than one axis has the largest absolute value with respect to the result of division performed by the maximum displacement axis calculation means 2, there may be more than one maximum displacement axis.

Note that when the absolute value of the result of division performed by the maximum displacement axis calculation means 2 on the above axis other than the maximum displacement axis and the absolute value of the result of division performed by the maximum displacement axis calculation means 2 on the above maximum displacement axis have a ratio therebetween that is greater than or equal to a predetermined value, that above axis may also be regarded as maximum displacement axis, and an axis other than these axes may be regarded as non-maximum displacement axis. However, the following description assumes that only the axis having the largest absolute value of the result of division performed by the maximum displacement axis calculation means 2 is the maximum displacement axis.

When command generation means is provided downstream of the path generation device 1, and the command generation means provides acceleration and deceleration and generates a command of every control period, the path generation device 1 does not necessarily need to provide acceleration and deceleration along the path. The first embodiment assumes that command generation means is provided downstream of the path generation device 1, and the command generation means provides acceleration and deceleration and generates a command of every control period. The command generation means is not illustrated in FIG. 1.

The initial passing point calculation means 3 generates, at a constant time interval, initial passing points to be used when the multiple axes of the control target move from the motion start point to the motion end point in synchronization with one another without acceleration or deceleration. FIG. 2 is a diagram illustrating a first example of modification on the amount of displacement between passing points in the first embodiment. FIG. 2 illustrates a relationship between the amount of displacement, which is equivalent to time, and the amount of displacement between passing points when the control target has a single maximum displacement axis and a single non-maximum displacement axis. FIG. 2 also illustrates an interference area.

The interference area extraction means 4 prestores information needed for interference determination, such as the position and size of an obstacle near the control target such as a robot. The interference area extraction means 4 determines whether interference will occur at each of multiple passing points on the basis of the stored information needed for interference determination and on the basis of position information of each of the multiple passing points calculated by the initial passing point calculation means 3. When the interference area extraction means 4 determines that interference will occur at one of the multiple passing points, the interference area extraction means 4 extracts, as the interference area, a section including the passing point at which it is determined that interference will occur.

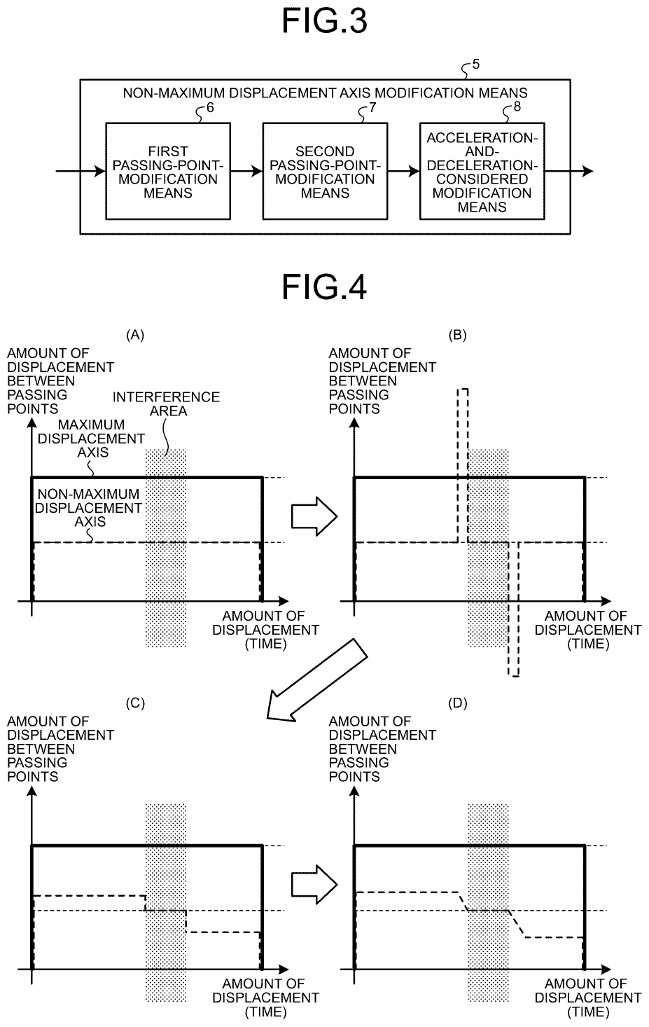

FIG. 3 is a diagram illustrating a configuration of the non-maximum displacement axis modification means 5 included in the path generation device 1 according to the first embodiment. The non-maximum displacement axis modification means 5 includes first passing-point-modification means 6, which modifies the position of each of non-maximum displacement axis or axes (hereinafter referred to simply and representatively as the non-maximum displacement axis, including the plural) at a passing point in the interference area; second passing-point-modification means 7, which modifies the position of the non-maximum displacement axis before and after the interference area; and acceleration-and-deceleration-considered modification means 8, which modifies the position of the non-maximum displacement axis at a passing point taking into account limitation on acceleration or on torque.

The first passing-point-modification means 6 first modifies the position of the non-maximum displacement axis at the passing point contained in the interference area extracted, among the multiple passing points generated by the initial passing point calculation means 3 while maintaining the position of the maximum displacement axis to thus generate a passing point that leads to avoidance of interference. The first passing-point-modification means 6 may perform modification in a predetermined direction or in an optimum direction selected based on an evaluation function. The first embodiment assumes that the first passing-point-modification means 6 performs modification in a predetermined direction.

The first passing-point-modification means 6 calculates a moving direction for use when only the maximum displacement axis is to be moved at the passing point included in the interference area, selects a perpendicularly upward direction with respect to the moving direction and two horizontal directions perpendicular to each other with respect to the moving direction as candidates for a detour direction, and determines, as the detour direction, the direction that will provide a smallest maximum value of the absolute value of the result of dividing the amount of displacement of the non-maximum displacement axis by the maximum speed of the non-maximum displacement axis in the operation for avoiding interference.

When the control target is a six-axis vertical articulated robot, the first passing-point-modification means 6 may select the two nearest axes from the root among multiple non-maximum displacement axes, and determine, of the directions of these two axes, the direction that will provide a smallest maximum value of the absolute value of the result of dividing the amount of displacement by the maximum speed of the axis, to be the detour direction. FIG. 2(B) is a diagram illustrating a result of passing point modification performed by the first passing-point-modification means 6.

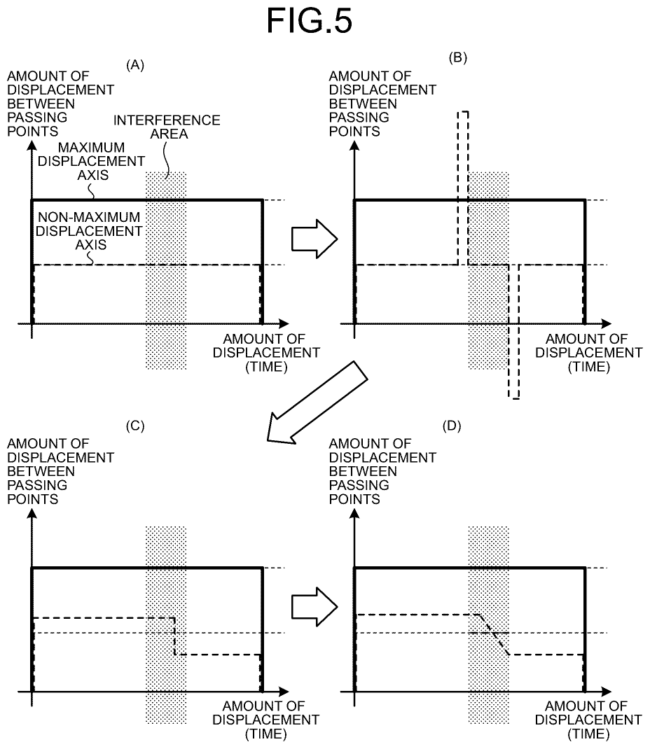

In FIG. 2(B), the speed of the non-maximum displacement axis exceeds a maximum permissible speed of the non-maximum displacement axis, and the second passing-point-modification means 7 accordingly modifies the position of the non-maximum displacement axis at each of passing points before and after the interference area. The second passing-point-modification means 7 may perform modification as illustrated in FIG. 2(C), 4(C), or 5(C). FIG. 4 is a diagram illustrating a second example of modification on the amount of displacement between passing points performed in the first embodiment. FIG. 4 illustrates a relationship between the amount of displacement, which is equivalent to time, and the amount of displacement between passing points when the control target has a single maximum displacement axis and a single non-maximum displacement axis. FIG. 5 is a diagram illustrating a third example of modification on the amount of displacement between passing points performed in the first embodiment. FIG. 5 illustrates a relationship between the amount of displacement, which is equivalent to time, and the amount of displacement between passing points when the control target has a single maximum displacement axis and a single non-maximum displacement axis.

In each of FIG. 2, FIG. 4, and FIG. 5, the upper left diagram (A) illustrates the passing points generated by the initial passing point calculation means 3; the upper right diagram (B) illustrates the passing points obtained by modification performed by the first passing-point-modification means 6; the lower left diagram (C) illustrates the passing points obtained by modification performed by the second passing-point-modification means 7; and the lower right diagram (D) illustrates the passing point obtained by modification performed by the acceleration-and-deceleration-considered modification means 8. The passing points are generated or modified in the order of the illustrations in the upper left, the upper right, the lower left, and the lower right.

Through FIG. 2, FIG. 4, and FIG. 5, the upper left and upper right diagrams illustrate the same passing points, and the lower left and later diagrams differ from one another correspondingly to the modification process performed by the second passing-point-modification means 7. The second passing-point-modification means 7 modifies the position of the non-maximum displacement axis at each of the passing points in the interference area and before and after the interference area under a condition of satisfying the speed limit of the non-maximum displacement axis and achieving interference avoidance simultaneously.

In an area in which the maximum displacement axis moves at a maximum speed, the maximum displacement axis desirably does not decelerate even in a process after the command generation means disposed downstream of the path generation device 1. Because no consideration is given to an effect of acceleration or deceleration in and before the second passing-point-modification means 7, this would require the command generation means disposed downstream of the path generation device 1 to decelerate the maximum displacement axis, and this would then increase the motion time if no measures were taken. As such, to allow the maximum displacement axis to be maintained at the maximum speed without need for acceleration or deceleration in a process after the command generation means disposed downstream, the acceleration-and-deceleration-considered modification means 8 modifies the position of the non-maximum displacement axis at each of the passing points.

Specifically, the acceleration-and-deceleration-considered modification means 8 places a limitation on the variable range of the amount of displacement or of the moving speed between passing points of the non-maximum displacement axis on the basis of a predetermined or calculated acceleration limit value or limit value of the time of acceleration or deceleration (hereinafter referred to simply as acceleration-deceleration time). The acceleration-and-deceleration-considered modification means 8 may place a limitation on the variable range of the amount of displacement between passing points of the non-maximum displacement axis on the basis of a predetermined or calculated torque limit value.

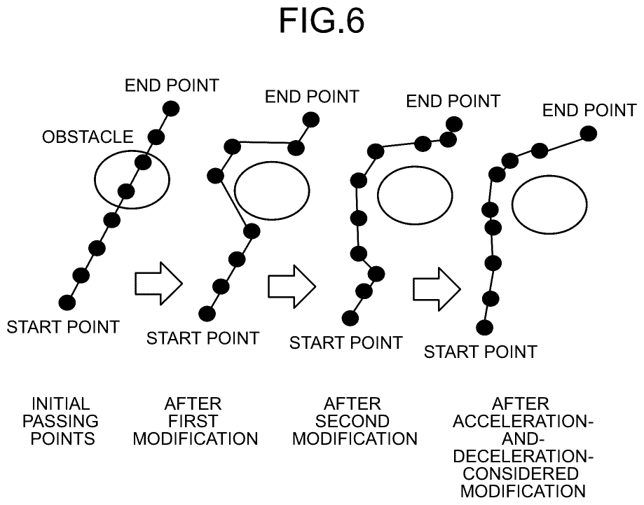

When the second passing-point-modification means 7 has performed modification to generate the result illustrated in FIG. 2(C), 4(C), or 5(C), the acceleration-and-deceleration-considered modification means 8 performs modification such that the situation of FIG. 2(C) is modified to result in the situation of FIG. 2(D), the situation of FIG. 4(C) is modified to result in the situation of FIG. 4(D), and the situation of FIG. 5(C) is modified to result in the situation of FIG. 5(D). Note that FIG. 6 is a diagram for illustrating the positional changes of the passing points when the modification of FIG. 2 is performed.

The acceleration-and-deceleration-considered modification means 8 outputs the passing points obtained by the modification to the command generation means as a target path. The command generation means generates a command that satisfies constraints on the speed and acceleration or drive torque of the control target along the target path that has been input, to thus control the control target such as a robot.

In the foregoing situation, the non-maximum displacement axis can complete a motion earlier than the maximum displacement axis in a first section from the motion start point to the interference area start point and in a second section from the interference area end point to the motion end point. However, there may be a case where the non-maximum displacement axis fails to complete a motion earlier than the maximum displacement axis in one or both of the foregoing first section and second section.

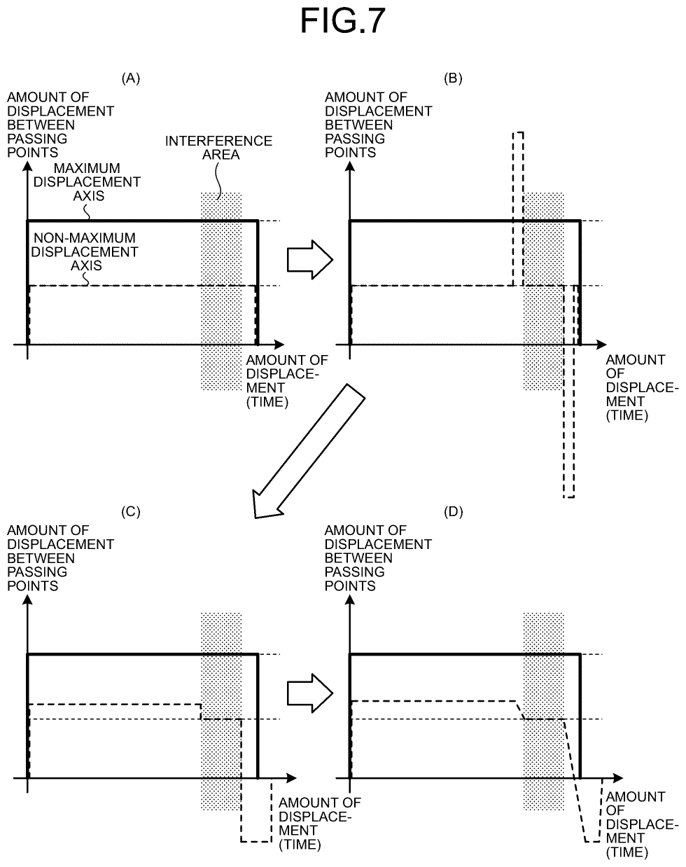

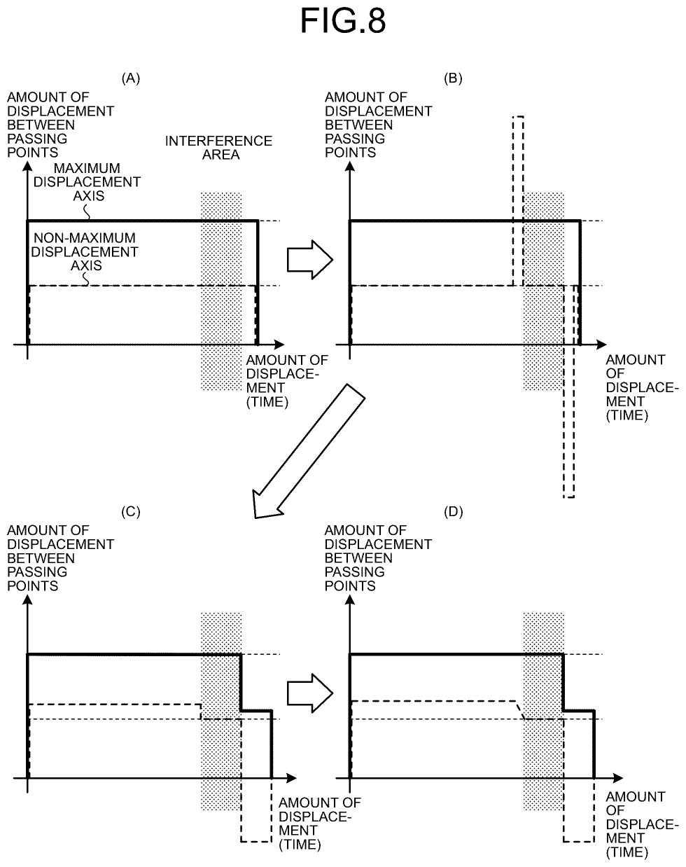

FIG. 7 is a diagram illustrating a fourth example of modification on the amount of displacement between passing points performed in the first embodiment. FIG. 8 is a diagram illustrating a fifth example of modification on the amount of displacement between passing points performed in the first embodiment. FIGS. 7 and 8 each illustrate a result of passing point modification when the non-maximum displacement axis fails to complete a motion earlier than the maximum displacement axis in the second section from the interference area end point to the motion end point. FIGS. 7 and 8 illustrate respective results of passing point generation performed on a same case, but the results of modification performed by the second passing-point-modification means 7 are different. FIG. 7 illustrates a case where the maximum displacement axis is not modified, but only the non-maximum displacement axis is modified, and the motion of the non-maximum displacement axis terminates after the motion of the maximum displacement axis terminates. FIG. 8 illustrates a case where the non-maximum displacement axis and the maximum displacement axis are both modified. Specifically, in the case of FIG. 8, the moving speed of the maximum displacement axis is reduced to cause the motion of the maximum displacement axis and the motion of the non-maximum displacement axis to terminate simultaneously.

The path generation device 1 according to the first embodiment generates a path that allows the maximum displacement axis to be maintained at the maximum speed as close as possible. This can provide an advantage in capability of generating a path that reduces the motion time while avoiding interference. In addition, non-use of a random number in passing point generation provides an advantage of capability of searching for a target path in a short time, and an advantage of reduction in a variation across trials. Moreover, taking into account an effect of acceleration or deceleration when the non-maximum displacement axis is moved to avoid interference prevents unwanted acceleration and deceleration of the maximum displacement axis, and thus provides an advantage of capability of reducing the motion time. That is, the path generation device 1 is capable of generating an optimum path that reduces the motion time while avoiding interference, capable of searching for a target path in a relatively short time, and capable of reducing the variation across trials.

### Second Embodiment

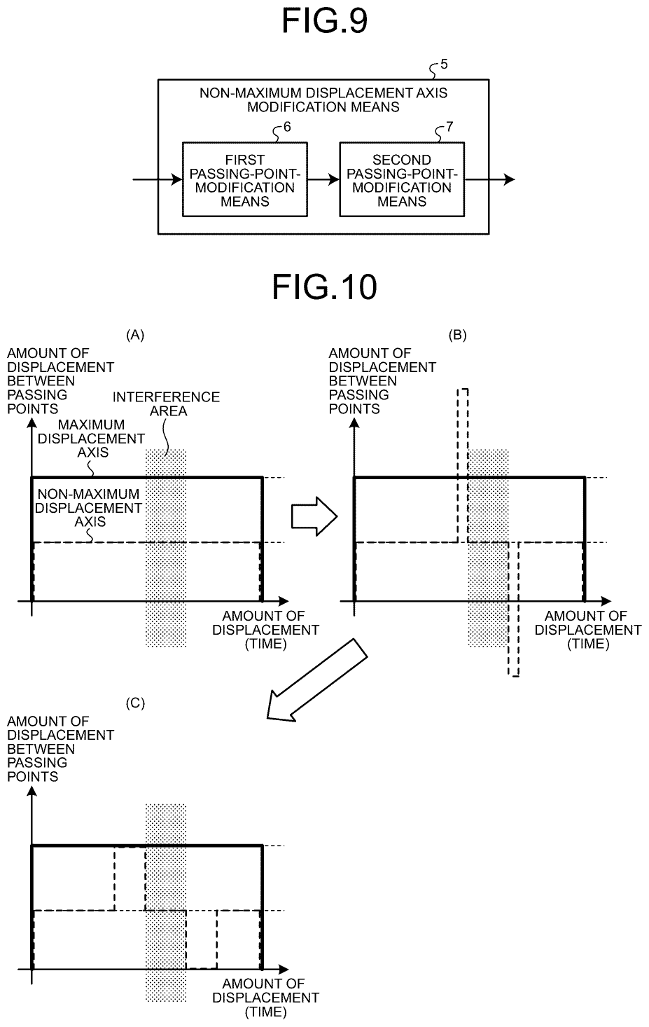

The illustrative diagram of FIG. 1 also applies to an overall configuration of the path generation device according to a second embodiment, but the non-maximum displacement axis modification means 5 of the second embodiment is configured differently from the non-maximum displacement axis modification means 5 of the first embodiment. FIG. 9 is a diagram illustrating a configuration of the non-maximum displacement axis modification means 5 included in the path generation device according to the second embodiment. The non-maximum displacement axis modification means 5 of the second embodiment includes the components other than the acceleration-and-deceleration-considered modification means 8 among all the components included in the non-maximum displacement axis modification means 5 of the first embodiment. That is, the non-maximum displacement axis modification means 5 of the second embodiment includes the first passing-point-modification means 6 and the second passing-point-modification means 7 included in the non-maximum displacement axis modification means 5 of the first embodiment, but does not include the acceleration-and-deceleration-considered modification means 8.

For example, in a same case as one illustrated in FIG. 2, the result of passing point modification as illustrated up to the lower left diagram can be obtained as illustrated in FIG. 10. FIG. 10 is a diagram illustrating an example of modification on the amount of displacement between passing points performed in the second embodiment. In the second embodiment, the result of modification performed by the second passing-point-modification means 7 is output to the command generation means downstream thereof. Thus, the second embodiment does not provide the advantage of preventing unwanted acceleration and deceleration of the maximum displacement axis, but provides an advantage of capability of generating a path that reduces the motion time while avoiding interference. In addition, non-use of a random number in passing point generation provides an advantage of capability of searching for a target path in a short time, and an advantage of reduction in a variation across trials.

### Third Embodiment

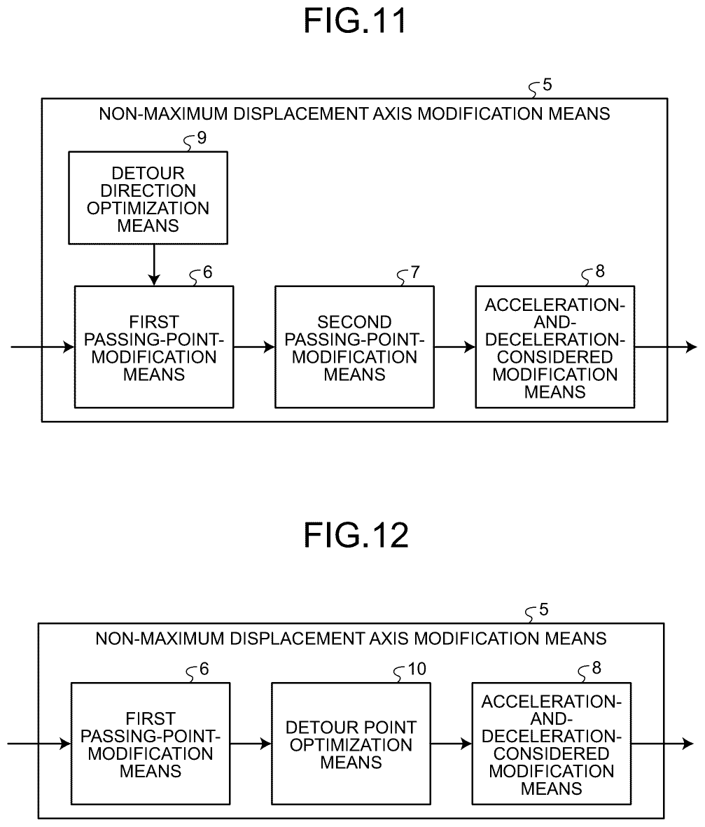

The illustrative diagram of FIG. 1 also applies to an overall configuration of the path generation device according to a third embodiment, but the non-maximum displacement axis modification means 5 of the third embodiment is configured differently from the non-maximum displacement axis modification means 5 of the first embodiment. FIG. 11 is a diagram illustrating a configuration of the non-maximum displacement axis modification means 5 included in the path generation device according to the third embodiment. The non-maximum displacement axis modification means 5 of the third embodiment includes all the components included in the non-maximum displacement axis modification means 5 of the first embodiment and detour direction optimization means 9. That is, the non-maximum displacement axis modification means 5 of the third embodiment includes the first passing-point-modification means 6, the second passing-point-modification means 7, the acceleration-and-deceleration-considered modification means 8, and the detour direction optimization means 9.

The detour direction optimization means 9 optimizes the direction for modifying the position of the non-maximum displacement axis. To optimize the direction for a purpose of generating a path that achieves a shortest motion time while avoiding interference, a method may be used in which an optimum modification direction is selected based on an output of the command generation means disposed downstream of the path generation device according to the third embodiment. However, this method requires a relatively long time for optimization.

Accordingly, one of the following operations can be used as an evaluation function: optimization under a condition of providing a smallest maximum value of the result of dividing the amount of displacement of the non-maximum displacement axis by the maximum speed of the non-maximum displacement axis during movement in the detour direction; providing a smallest amount of displacement of the forward end position without allowing a permitted value to be exceeded by the maximum value of the result of dividing the amount of displacement of the non-maximum displacement axis by the maximum speed of the non-maximum displacement axis during movement in the detour direction; and providing smallest acceleration during movement in the detour direction without allowing a permitted value to be exceeded by the maximum value of the result of dividing the amount of displacement of the non-maximum displacement axis by the maximum speed of the non-maximum displacement axis during movement in the detour direction.

The detour direction optimization means 9 may use an artificial intelligence technology. For example, the detour direction optimization means 9 may use a technique such as Bayesian optimization, particle swarm optimization, or genetic algorithm.

The detour direction optimization means 9 may use a neural network that has learned an optimum detour direction on the basis of information about the motion start point, the motion end point, and the position and size of an interfering object. Owing to ability to generate a path and to generate a command value even in a virtual environment, a neural network may be trained in such a manner that calculation is repeatedly made in the virtual environment to preliminarily generate a detour direction that will achieve a shortest motion time after performing command generation at downstream thereof in the virtual environment, and the neural network then performs learning using, as an input, information about the motion start point, the motion end point, and the position and size of an interfering object, and using, as an output, the detour direction. Conditions for use in generation of a path may be input to a neural network that has performed learning, and the detour direction output by the neural network may be used as the detour direction provided by the non-maximum displacement axis modification means 5.

Because of inclusion of the detour direction optimization means 9, the path generation device according to the third embodiment can reduce the motion time as compared to when the detour direction is fixed.

### Fourth Embodiment

The illustrative diagram of FIG. 1 also applies to an overall configuration of the path generation device according to a fourth embodiment, but the non-maximum displacement axis modification means 5 of the fourth embodiment is configured differently from the non-maximum displacement axis modification means 5 of the first embodiment. FIG. 12 is a diagram illustrating a configuration of the non-maximum displacement axis modification means 5 included in the path generation device according to the fourth embodiment. The non-maximum displacement axis modification means 5 of the fourth embodiment includes the first passing-point-modification means 6 and the acceleration-and-deceleration-considered modification means 8 included in the non-maximum displacement axis modification means 5 of the first embodiment, and detour point optimization means 10. The non-maximum displacement axis modification means 5 of the fourth embodiment does not include the second passing-point-modification means 7 included in the non-maximum displacement axis modification means 5 of the first embodiment.

As described in the first embodiment, there are multiple methods for setting a detour point for a same detour direction. The motion time taken when a command is generated by the downstream command generation means taking into account a torque limit may vary depending on selection of the detour point. In addition, prevention of unwanted speed variation of the non-maximum displacement axis may allow prevention of increase in the motion time caused by acceleration or deceleration of the non-maximum displacement axis. Thus, in the fourth embodiment, the detour point optimization means 10 is provided which optimizes a specific detour point for a detour direction that has been determined.

The detour point optimization means 10 searches for a detour point that causes reduction in the speed variation of the non-maximum displacement axis and causes increase in acceleration that satisfies a torque constraint including that of the maximum displacement axis within a range where a constraint that allows avoiding interference is satisfied. The detour point optimization means 10 may use a technique such as Bayesian optimization, particle swarm optimization, or genetic algorithm in detour point searching as in the case of detour direction searching.

The detour point optimization means 10 may use a neural network that has learned an optimum detour point on the basis of the detour direction and on the basis of information about the motion start point, the motion end point, and the position and size of an interfering object. Owing to ability to generate a path and to generate a command value even in a virtual environment, a neural network may be trained in such a manner that calculation is repeatedly made in the virtual environment on a per condition basis to preliminarily generate a detour direction that will achieve a shortest motion time after performing command generation at downstream thereof in the virtual environment, and the neural network then performs learning using, as an input, information about the detour direction, the motion start point, the motion end point, and the position and size of an interfering object, and using, as an output, the detour point. Conditions for use in generation of a path may be input to a neural network that has performed learning, and the detour point output by the neural network may be used as the detour point generated by the detour point optimization means 10.

Because of inclusion of the detour point optimization means 10, the path generation device according to the fourth embodiment can reduce the motion time as compared to when the method of calculating a detour point is fixed.

### Fifth Embodiment

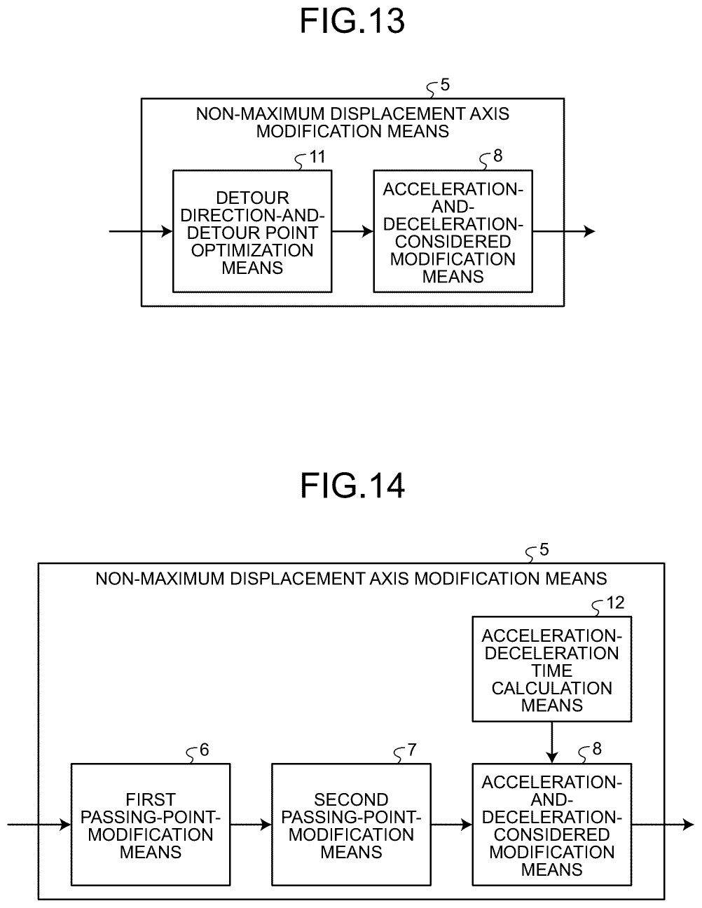

The illustrative diagram of FIG. 1 also applies to an overall configuration of the path generation device according to a fifth embodiment, but the non-maximum displacement axis modification means 5 of the fifth embodiment is configured differently from the non-maximum displacement axis modification means 5 of the first embodiment. FIG. 13 is a diagram illustrating a configuration of the non-maximum displacement axis modification means 5 included in the path generation device according to the fifth embodiment. The non-maximum displacement axis modification means 5 of the fifth embodiment includes detour direction-and-detour point optimization means 11, and the acceleration-and-deceleration-considered modification means 8 included in the non-maximum displacement axis modification means 5 of the first embodiment. The non-maximum displacement axis modification means 5 of the fifth embodiment does not include the first passing-point-modification means 6 and the second passing-point-modification means 7 included in the non-maximum displacement axis modification means 5 of the first embodiment.

The path generation device according to the third embodiment includes the detour direction optimization means 9, which optimizes the detour direction, and the path generation device according to the fourth embodiment includes the detour point optimization means 10, which optimizes generation of the detour point after the detour direction is determined. The path generation device according to the fifth embodiment includes the detour direction-and-detour point optimization means 11, which optimizes the detour direction and the detour point in combination. Similarly to the detour direction optimization means 9 and the detour point optimization means 10, the detour direction-and-detour point optimization means 11 performs a search using an optimization technique such as Bayesian optimization, particle swarm optimization, or genetic algorithm, or uses a neural network, and outputs a detour direction and a detour point.

Because of inclusion of the detour direction-and-detour point optimization means 11, the path generation device according to the fifth embodiment can reduce the motion time as compared to when the methods of calculating a detour direction and a detour point are fixed.

### Sixth Embodiment

The illustrative diagram of FIG. 1 also applies to an overall configuration of the path generation device according to a sixth embodiment, but the non-maximum displacement axis modification means 5 of the sixth embodiment is configured differently from the non-maximum displacement axis modification means 5 of the first embodiment. FIG. 14 is a diagram illustrating a configuration of the non-maximum displacement axis modification means 5 included in the path generation device according to the sixth embodiment. The non-maximum displacement axis modification means 5 of the sixth embodiment includes all the components included in the non-maximum displacement axis modification means 5 of the first embodiment and acceleration-deceleration time calculation means 12. That is, the non-maximum displacement axis modification means 5 of the sixth embodiment includes the first passing-point-modification means 6, the second passing-point-modification means 7, the acceleration-and-deceleration-considered modification means 8, and the acceleration-deceleration time calculation means 12.

The acceleration-deceleration time calculation means 12 calculates the acceleration-deceleration time to be used by the acceleration-and-deceleration-considered modification means 8 to modify a passing point when the speeds of the non-maximum displacement axes vary. The acceleration-deceleration time calculation means 12 calculates the minimum value of kt satisfying Expression (1) below for each of all the axes, and outputs a maximum value ktm of all values of kt of the respective axes as the acceleration-deceleration time, where Vc is a vector formed from speed differences of the respective axes each at a point where the speed of the corresponding non-maximum drive axis varies, V is the speeds of the respective axes, θ is the positions of the respective axes, θ(M) is an inertia matrix of a robot that is the control target, H(θ, V) is a vector formed from sums of centrifugal Coriolis force, gravity, and frictional force, and τmax is a vector formed from maximum permissible torques of the respective axes.

### Formula 1:

$$- τmax ≦ M ( θ ) \cdot Vc / kt + H ( θ , V ) ≦ τmax \qquad ( 1 )$$

The acceleration-and-deceleration-considered modification means 8 modifies a passing point to cause the speeds of the non-maximum displacement axes to vary with the acceleration-deceleration time ktm output from the acceleration-deceleration time calculation means 12.

The path generation device according to the sixth embodiment determines acceleration and deceleration of the non-maximum displacement axis taking into account the amount of speed change, and the position and posture, the moving speed, and the torque limit of the control target, and can thus reduce the motion time as compared to when an acceleration-deceleration parameter has a fixed value.

### Seventh Embodiment

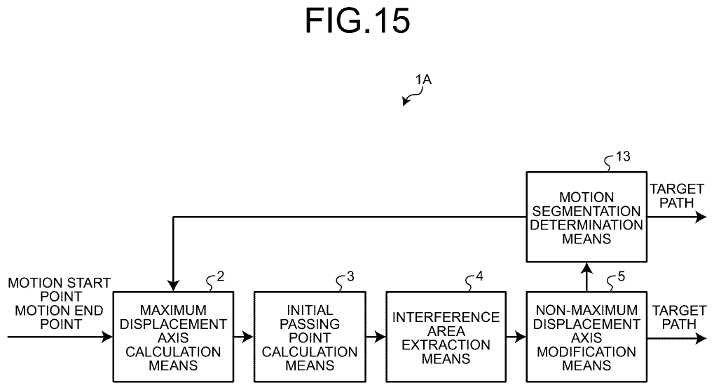

FIG. 15 is a diagram illustrating a configuration of a path generation device 1A according to a seventh embodiment. The path generation device 1A includes all the components included in the path generation device 1 according to the first embodiment and motion segmentation determination means 13. That is, the path generation device 1A includes the maximum displacement axis calculation means 2, the initial passing point calculation means 3, the interference area extraction means 4, the non-maximum displacement axis modification means 5, and the motion segmentation determination means 13. The path generation device 1 according to the first embodiment treats a movement from the motion start point to the motion end point as a single motion to generate a path in consideration of interference. The path generation device 1A according to the seventh embodiment tentatively performs computation of components from the maximum displacement axis calculation means 2 to the non-maximum displacement axis modification means 5, treating a motion from the motion start point to the motion end point as a single motion.

When an interference avoidance operation causes the motion time of the non-maximum displacement axis to exceed the motion time of the maximum displacement axis, the path generation device 1A causes the motion segmentation determination means 13 to determine whether the motion from the motion start point to the motion end point should be segmented into two or more motions. When the motion segmentation determination means 13 determines that the motion should not be segmented, the path generation device 1A outputs the output of the non-maximum displacement axis modification means 5 as the generated path. When the motion segmentation determination means 13 determines that the motion should be segmented into two or more motions, the maximum displacement axis calculation means 2, the initial passing point calculation means 3, the interference area extraction means 4, and the non-maximum displacement axis modification means 5 perform processing on each of multiple motions generated by the segmentation, and regard and output the results of the processing as the generated paths associated with the multiple respective motions generated by the segmentation.

The motion segmentation determination means 13 compares the sum of moving times of the maximum displacement axis without acceleration or deceleration, of the multiple respective motions generated when the motion has been segmented into two or more motions, with the moving time before the motion is segmented, obtained by the non-maximum displacement axis modification means 5. When the moving time before the motion is segmented, obtained by the non-maximum displacement axis modification means 5, is less than the sum of moving times obtained when the motion has been segmented, the motion segmentation determination means 13 determines that the motion is not to be segmented. The motion is segmented, for example, by setting a middle point in each of multiple directions predetermined at the midpoint of the interference area as of before segmentation. The motion segmentation determination means 13 determines the direction of the middle point and the amount of displacement of the middle point from the interference area by searching for a combination that minimizes the sum of moving times of the maximum displacement axis of the multiple respective motions generated by the segmentation.

In other words, the motion segmentation determination means 13 determines whether the motion should be segmented. The path generation device 1A according to the seventh embodiment generates a path for each of the multiple motions generated when the motion segmentation determination means 13 has determined that the motion should be segmented. The path generation device 1A can reduce the motion time required when a more optimum path set can be obtained by generating a path set by segmentation of the motion into two or more motions.

The non-maximum displacement axis modification means 5 in the seventh embodiment may be the non-maximum displacement axis modification means 5 of any one of the first through sixth embodiments.

### Eighth Embodiment

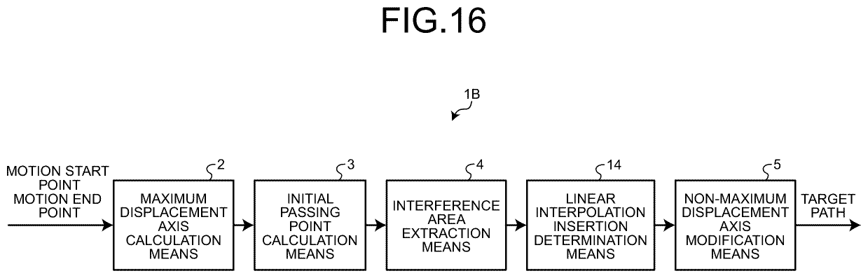

FIG. 16 is a diagram illustrating a configuration of a path generation device 1B according to an eighth embodiment. The path generation device 1B includes all the components included in the path generation device 1 according to the first embodiment and linear interpolation insertion determination means 14. That is, the path generation device 1B includes the maximum displacement axis calculation means 2, the initial passing point calculation means 3, the interference area extraction means 4, the non-maximum displacement axis modification means 5, and the linear interpolation insertion determination means 14. When multiple obstacles are present in a small area, there may be a case where it is desirable to generate a path in a corresponding section by linear interpolation for causing the hand end portion of the robot to move linearly, for a reason such as necessity to set passing points to a fine degree on a per-axis basis. The foregoing operation of linearly moving the hand end portion of the robot is equivalent to linearly moving the control point of the control target.

To this end, when another obstacle is present within a predetermined distance from an obstacle determined by the interference area extraction means 4 to interfere, the linear interpolation insertion determination means 14 determines that the obstacle is to be avoided by linear interpolation. That is, the linear interpolation insertion determination means 14 determines that linear interpolation insertion is to be performed. When the linear interpolation insertion determination means 14 determines that linear interpolation insertion is to be performed, the first passing-point-modification means 6 of the non-maximum displacement axis modification means 5 generates a passing point by linear interpolation, and sets a flag of linear interpolation to a section ending at the detour point.

When the speed in a section ending at the passing point generated by the first passing-point-modification means 6 exceeds the maximum speed of the maximum displacement axis or of the non-maximum displacement axis, the second passing-point-modification means 7 adds a new passing point on the line segment from the original passing point to the passing point generated by the first passing-point-modification means 6 to thus generate a passing point that will not cause the speed to exceed the maximum speed. When the acceleration in a section ending at the passing point generated by the first passing-point-modification means 6 exceeds a preset acceleration value, the acceleration-and-deceleration-considered modification means 8 adds a new passing point on the line segment ending at the passing point generated by the first passing-point-modification means 6 to thus generate a passing point that will not cause the acceleration to exceed the acceleration limit.

In other words, the linear interpolation insertion determination means 14 determines whether interference should be avoided by linear interpolation for causing the control point of the control target to move linearly. The path generation device 1B according to the eighth embodiment performs interference avoidance operation by linear interpolation when the linear interpolation insertion determination means 14 has determined that interference should be avoided by linear interpolation. The path generation device 1B can reduce the motion time required when it is desirable to linearly move the forward end of the control target to avoid interference.

The non-maximum displacement axis modification means 5 in the eighth embodiment may be the non-maximum displacement axis modification means 5 of any one of the first through seventh embodiments.

### Ninth Embodiment

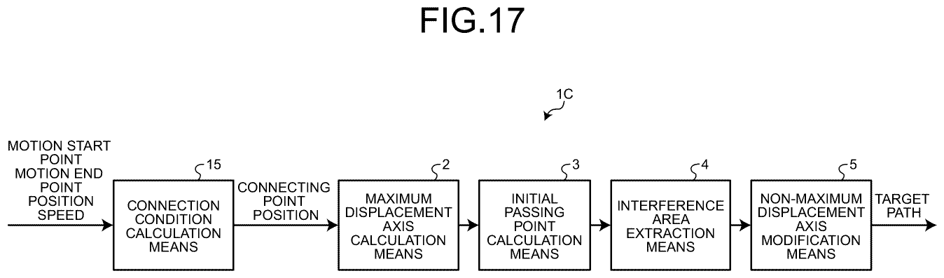

FIG. 17 is a diagram illustrating a configuration of a path generation device 1C according to a ninth embodiment. The path generation device 1C includes all the components included in the path generation device 1 according to the first embodiment and connection condition calculation means 15. That is, the path generation device 1C includes the maximum displacement axis calculation means 2, the initial passing point calculation means 3, the interference area extraction means 4, the non-maximum displacement axis modification means 5, and the connection condition calculation means 15.

Including a case where the control target is desired to move to near a target point and then to move linearly in a predetermined direction, such as a case of causing a robot to assembly electrical and electronics products, there is an application in which the magnitude of speed at one of the motion start point and the motion end point needs to be specified at a non-zero value. To support generation of a path suitable for a command including a speed having a specified direction and a specified magnitude as described above rather than stopping the control target at the motion start point or at the motion end point, the path generation device 1C includes the connection condition calculation means 15.

Information representing the position at the motion start point, the position at the motion end point, the speed at the motion start point, and the speed at the motion end point is input to the connection condition calculation means 15. When a non-zero value is set as the speed at the motion start point and as the speed at the motion end point, the connection condition calculation means 15 first calculates a moving speed V0 to be used when the axes move in synchronization with one another, on the basis of the position at the motion start point, the position at the motion end point, and the maximum speed of the corresponding one of the axes. Next, the connection condition calculation means 15 calculates the time required for the speed of each of the axes to reach the moving speed V0, which is the calculated speed to be used when the axes move in synchronization with one another, from the speed specified for the motion start point or for the motion end point. The connection condition calculation means 15 also calculates a displacement distance L1 of the movement occurring while the speed of that axis changes from the speed specified for the motion start point or for the motion end point to the moving speed V0, which is the speed to be used when the axes move in synchronization with one another. The connection condition calculation means 15 then calculates connecting point positions, which are positions in the motion section, inward respectively from the motion start point and the motion end point by the displacement distance L1 calculated. The connecting point positions are the start point and the end point of a section in which the axes move in synchronization with one another when no interference occurs. Next, the connection condition calculation means 15 calculates the speed of each of the axes to be used when the axes are moved in synchronization with one another between the connecting point position nearer to the motion start point and the connecting point position nearer to the motion end point, on the basis of the connecting point position nearer to the motion start point and the connecting point position nearer to the motion end point. The above speed of each of the axes is a connecting point speed.

When zero is set as the speed at the motion start point and as the speed at the motion end point, the connection condition calculation means 15 maintains the connecting position at the motion start point or at the motion end point. Next, the connection condition calculation means 15 repeats calculation of the time required for the speed to reach the connecting point speed calculated from the speed at the motion start point or from the speed at the motion end point, calculation of the displacement distance, and calculation of the connecting point positions in the motion section, inward by the displacement distance calculated, and the connecting point speed. When the number of times of repetition reaches a predetermined number of times, or when the difference from the previous value reaches or falls below a predetermined value in each of the speed and the position, the connection condition calculation means 15 outputs the connecting point positions and the connecting point speeds calculated, to the maximum displacement axis calculation means 2.

The maximum displacement axis calculation means 2 calculates the maximum displacement axis on the basis of information of the connecting point positions that has been input, and takes one of the two connecting points as the motion start point and the other of the two connecting points as the motion end point. The initial passing point calculation means 3, the interference area extraction means 4, and the non-maximum displacement axis modification means 5 each perform processing similar to the processing of the first embodiment.

A method for deriving the connecting point positions will be described below. In the following description, an axis-specific moving speed V0[i] is a speed to be used when the axes move in synchronization with one another when no interference occurs; a time T1max to move to the connecting point is the maximum value of the time required for the speed of the corresponding one of the axes to reach V0[i] from a speed specified for the motion start point or for the motion end point; and an axis-specific amount of displacement L1[i] is the distance moved by that axis during the time T1max. The displacement distance is calculated by integration of the speed.

An example will be described below in which the speed at the motion start point has been specified. The position, the speed, the acceleration, and the like of an i-th axis of the control target are indexed by [i]. The control target is, for example, a robot. Let Ps[i] denote the position at the motion start point, Vs[i] denote the specified speed at the motion start point, and Pe[i] denote the position at the motion end point. In this situation, first, the connection condition calculation means 15 calculates the axis-specific moving speed V0[i] when the axes move from the motion start point to the motion end point in synchronization with one another. Specifically, the connection condition calculation means 15 calculates the axis-specific moving speed V0[i] using Expression (2) below.

### Formula 2:

$$V 0 [ i ] = ( Pe [ i ] - Ps [ i ] ) / ( max ( abs ( ( Pe [ i ] - Ps [ i ] ) / V max [ i ] ) ) \qquad ( 2 )$$

In Expression (2), Vmax[i] represents the highest permissible speed of the corresponding one of the axes, abs represents the absolute value, and max represents the maximum value of the calculation result of that axis. Next, the connection condition calculation means 15 calculates Ve1[i], which is a difference between the value of Vs[i], which is the specified speed at the motion start point, and the value of V0[i] calculated, using Expression (3) below.

### Formula 3:

$$Ve 1 [ i ] = V 0 [ i ] - Vs [ i ] \qquad ( 3 )$$

The connection condition calculation means 15 calculates the value of T1[i] using Expression (4) below, where Kt is the acceleration-deceleration time that has been specified or derived in advance.

### Formula 4:

$$T 1 [ i ] = abs ( Ve 1 [ i ] ) \cdot Kt / V max [ i ] \qquad ( 4 )$$

Letting T1max denote the maximum value of T1[i] of the axes, the time to move to the connecting point is T1max. Next, the connection condition calculation means 15 calculates the axis-specific amount of displacement L1[i] of when the speed is changed from Vs[i] to V0[i] at a constant acceleration in the time T1max, and determines that a sum Ps[i]+L1[i] is Pa1[i], which is the position of the i-th axis at a connecting point Pa1. An example has been described in which the speed at the motion start point has been specified, but a similar method also applies to a case where the speed at the motion end point is specified.

In other words, the connection condition calculation means 15 calculates the positions of the connecting points on the basis of specification of the direction and magnitude of a target speed at at least one of the motion start point and the motion end point. The path generation device 1C according to the ninth embodiment generates a path on the basis of the positions of the connecting points calculated by the connection condition calculation means 15. The path generation device 1C can reduce the motion time in the case where the speeds of the respective axes at at least one of the motion start point and the motion end point are specified.

The non-maximum displacement axis modification means 5 in the ninth embodiment may be the non-maximum displacement axis modification means 5 of any one of the first through eighth embodiments.

### Tenth Embodiment

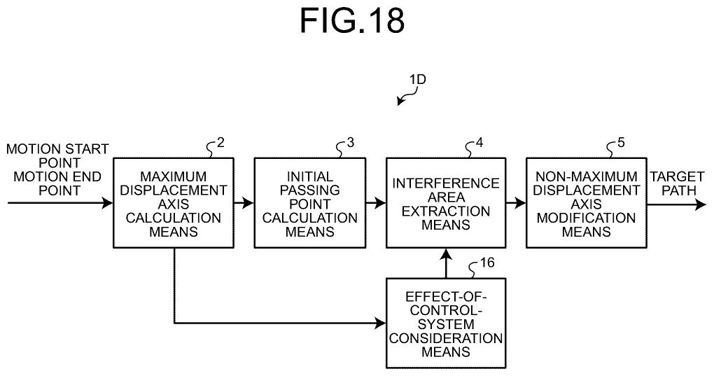

FIG. 18 is a diagram illustrating a configuration of a path generation device 1D according to a tenth embodiment. The path generation device 1D includes all the components included in the path generation device 1 according to the first embodiment and effect-of-control-system consideration means 16. That is, the path generation device 1D includes the maximum displacement axis calculation means 2, the initial passing point calculation means 3, the interference area extraction means 4, the non-maximum displacement axis modification means 5, and the effect-of-control-system consideration means 16. Information of the path generated by the path generation device 1D is input to the command generation means downstream thereof, and the command generation means generates a command of every control period that satisfies a constraint on the speed and torque of each of the axes while maintaining the path generated by the path generation device 1D to thus control the control target. The control target is controlled usually with delay, thereby causing the control target to fail in fact to correctly follow the path generated by the path generation device, but to pass along a more inward route due to an effect of the control system.

Accordingly, the path generation device 1D takes into account the effect of the control system and virtually increases the size of the obstacle, stored in the interference area extraction means 4, to thereby generate a path that will prevent occurrence of interference even when the course of the control target is deflected due to an effect of the control system. Considering variability of characteristics of the control system depending on the position of the control target, the effect-of-control-system consideration means 16 obtains information about the motion start point and about the motion end point, and determines the amount of change or the change rate of the size of the obstacle also taking into account a characteristic of the control system in the motion area.

In other words, the effect-of-control-system consideration means 16 estimates an effect of deflection of the course of the control target from the target path, caused by the control system. The path generation device 1D modifies the value of a parameter (hereinafter, simply parameter) with respect to the obstacle, internal to the interference area extraction means 4, on the basis of the output from the effect-of-control-system consideration means 16. The path generation device 1D is capable of taking into account the effect of deflection of the course of the control target caused by a characteristic of the control system, and is thus capable of generating a path that enables more accurate avoidance.

The non-maximum displacement axis modification means 5 in the tenth embodiment may be the non-maximum displacement axis modification means 5 of any one of the first through ninth embodiments.

### Eleventh Embodiment

The illustrative diagram of FIG. 1 also applies to an overall configuration of the path generation device according to an eleventh embodiment, but the non-maximum displacement axis modification means 5 of the eleventh embodiment is configured differently from the non-maximum displacement axis modification means 5 of the first embodiment. In the eleventh embodiment, the interference area extraction means 4 extracts multiple interference areas. When multiple interference areas are present, the first passing-point-modification means 6 determines the detour direction under a condition that a same detour direction of the non-maximum displacement axis is applicable to the multiple interference areas. The second passing-point-modification means 7 does not make a modification to cause the non-maximum displacement axis to return to the initial passing point, but modifies the passing point to interconnect adjacent interference areas, between each pair of interference areas. The operation other than the above operation is the same as the operation described in the first embodiment, and description of the operation other than the above operation is therefore omitted.

The path generation device according to the eleventh embodiment can reduce the motion time while avoiding interference in the case where multiple obstacles are present on the moving route of the control target.

### Twelfth Embodiment

The illustrative diagram of FIG. 1 also applies to an overall configuration of the path generation device according to a twelfth embodiment. In the twelfth embodiment, however, no command generation means is provided downstream of the path generation device, and the path generated by the path generation device is used as the command of every control period. Because acceleration and deceleration that would be performed in the command generation means disposed downstream are not provided, the speed does not have a waveform of a speed rectangular wave, but the speed is accelerated or decelerated to thus have a waveform of a speed trapezoidal shape at the passing point calculated by the initial passing point calculation means 3. The slope of the speed trapezoidal shape may be calculated on the basis of the position of the motion start point, the position of the motion end point, and the maximum speeds of the respective axes taking into account the torque limit. The slope of the speed trapezoidal shape represents acceleration.

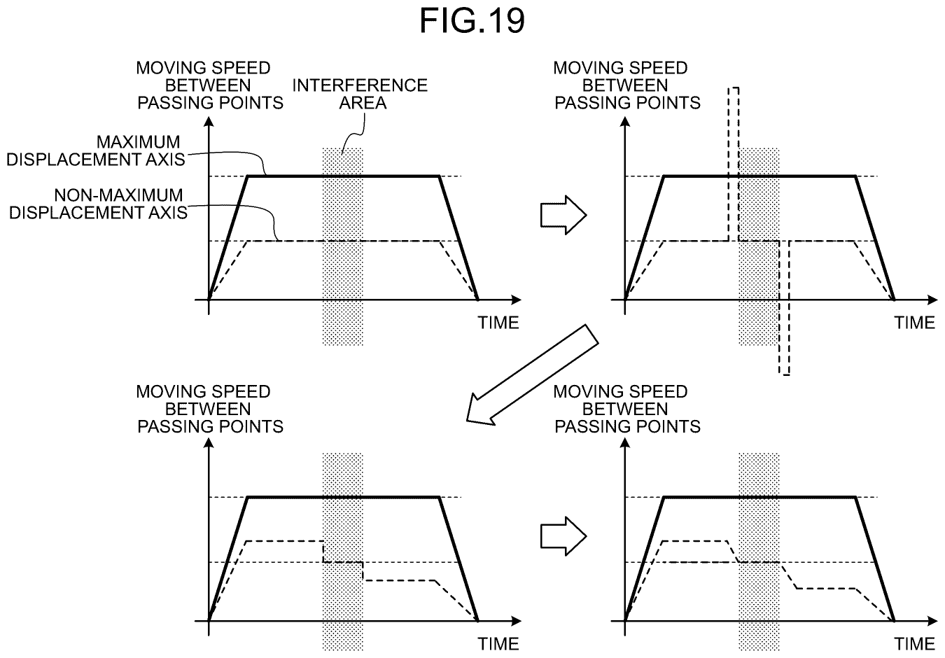

FIG. 19 is a diagram illustrating the amount of displacement of passing points in the twelfth embodiment. In FIG. 19, the upper left diagram illustrates the result of calculation performed by the initial passing point calculation means 3; the upper right diagram illustrates the result of modification performed by the first passing-point-modification means 6; the lower left diagram illustrates the result of modification performed by the second passing-point-modification means 7; and the lower right diagram illustrates the result of modification performed by the acceleration-and-deceleration-considered modification means 8. The path generation device according to the twelfth embodiment uses the output of the acceleration-and-deceleration-considered modification means 8 as the generated command to control the control target.

The path generation device according to the twelfth embodiment can reduce the computation time required for generating a command that provides reduction in the motion time while avoiding interference.

### Thirteenth Embodiment

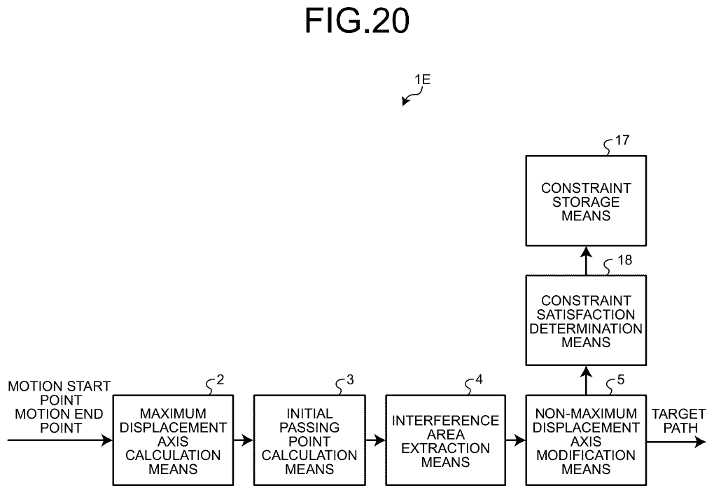

FIG. 20 is a diagram illustrating a configuration of a path generation device 1E according to a thirteenth embodiment. The path generation device 1E includes all the components included in the path generation device 1 according to the first embodiment, constraint storage means 17, and constraint satisfaction determination means 18. That is, the path generation device 1E includes the maximum displacement axis calculation means 2, the initial passing point calculation means 3, the interference area extraction means 4, the non-maximum displacement axis modification means 5, the constraint storage means 17, and the constraint satisfaction determination means 18. The constraint storage means 17 is implemented, for example, in a semiconductor memory. In the thirteenth embodiment, the non-maximum displacement axis modification means 5 modifies the position of the non-maximum displacement axis under a constraint based on kinematics of an articulated robot. In other words, the non-maximum displacement axis modification means 5 modifies the position of the non-maximum displacement axis taking into account the constraint based on kinematics of an articulated robot.

Examples of the constraint based on kinematics include a condition that a singular point is avoided in a motion under linear interpolation. In the field of articulated robot, a position at which an arm is in a completely stretched posture and a position at which two or more rotational axes are aligned in a straight line are each called singular point. The freedom of motion of the hand end portion is lower at a singular point, thereby preventing a unique determination of the combination of the positions of the respective joints for providing the hand end position and posture. An articulated robot can basically pass over a singular point on a path in a joint-interpolated motion, but when a path is to be generated for a part of section using linear interpolation as described in the eighth embodiment, the positions of the respective axes at the next control point can be indeterminate at a point near a singular point, which may cause an error to stop the operation of the articulated robot.

The constraint storage means 17 prestores a necessary condition of a singular point along the path. The constraint satisfaction determination means 18 determines whether the articulated robot will pass over a singular point before reaching the next passing point in terms of each of multiple candidates for the modification direction obtained by the first passing-point-modification means 6 and the second passing-point-modification means 7 included in the non-maximum displacement axis modification means 5. The constraint satisfaction determination means 18 thus prevents selection of a candidate for the modification direction that will cause the articulated robot to pass over a singular point. This can be achieved, for example, by checking whether each of points generated by dividing, at a regular interval, a line segment connecting two passing points is near a singular point using an evaluation function for an optimum modification direction, and when that point is near a singular point, giving a penalty to the evaluation value. This operation enables the path generation device 1E according to the thirteenth embodiment to obtain a path that enables a moving operation while avoiding a singular point, at which the combination of the positions of the respective axes for providing the hand end position of an articulated robot is not uniquely determinable, even when linear interpolation is used for motion of the articulated robot.

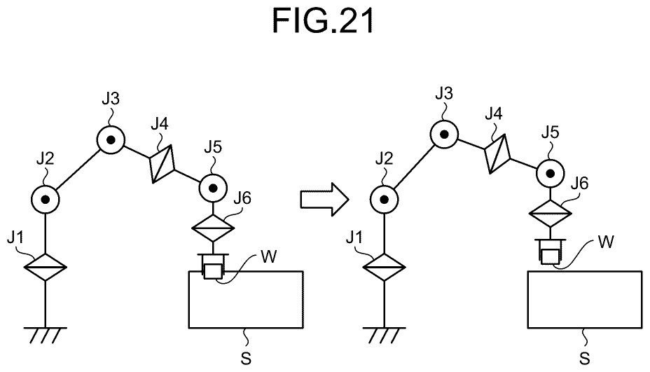

Another example of constraint is a condition of maintaining the hand end posture. FIG. 21 is a diagram for describing an example of modification on non-maximum displacement axes while maintaining the hand end posture, using a schematic diagram of a vertical articulated robot having six rotational axes from a rotational axis J1 to a rotational axis J6. For example, when a workpiece W would interfere with an obstacle S as illustrated in the left diagram of FIG. 21 while the robot hand is moving the workpiece W by moving the rotational axis J1, which is the maximum displacement axis, while maintaining the posture of the workpiece W in grasp in a horizontal posture, modification on the positions of the rotational axes J2, J3, and J5, which are non-maximum displacement axes, can avoid interference of the workpiece W with the obstacle S while maintaining the posture of the workpiece W as illustrated in the right diagram of FIG. 21. In this case, the hand end posture before modification has been set in the constraint storage means 17, and the first passing-point-modification means 6 and the second passing-point-modification means 7 obtain, using inverse kinematics calculation, the positions of the non-maximum displacement axes that will maintain the hand end posture. This can be achieved in such a manner, for example, when the modification direction of a passing point is to be determined in an interference area, a perpendicularly upward direction, a perpendicularly downward direction in an orthogonal space, and two directions perpendicular to each other with respect to the moving direction on the horizontal plane are selected as candidates for the detour direction of the hand end position, and the constraint satisfaction determination means 18 calculates, using inverse kinematics, the positions of the non-maximum displacement axes that will satisfy the constraint on the posture with respect to the hand end position for each of the candidates, and selects the direction that will provide a smallest maximum value of the absolute value of the result of dividing the amount of displacement of each of the non-maximum displacement axes by the maximum speed of that non-maximum displacement axis. In this case, processing of the constraint satisfaction determination means 18 may be included in processing of the first passing-point-modification means 6 and of the second passing-point-modification means 7 included in the non-maximum displacement axis modification means 5. This enables the path generation device 1E according to the thirteenth embodiment to obtain a path that enables a moving operation while maintaining the hand end posture in a horizontal posture.

A user may add or delete a constraint as needed using an external interface or the like.

The non-maximum displacement axis modification means 5 in the thirteenth embodiment may be the non-maximum displacement axis modification means 5 of any one of the first through seventh embodiments.

### Fourteenth Embodiment

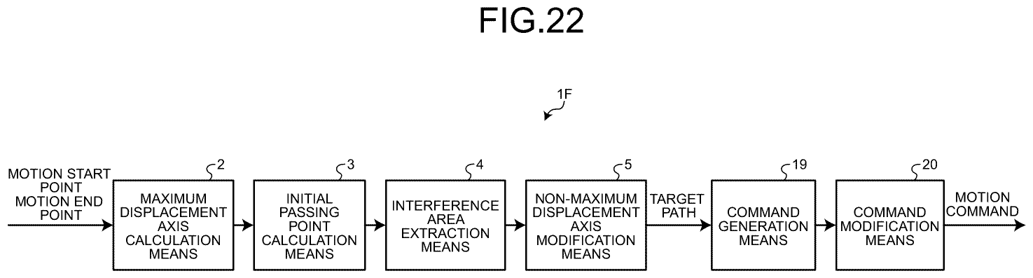

FIG. 22 is a diagram illustrating a configuration of a path generation device 1F according to a fourteenth embodiment. The path generation device 1F includes all the components included in the path generation device 1 according to the first embodiment, command generation means 19, and command modification means 20. That is, the path generation device 1F includes the maximum displacement axis calculation means 2, the initial passing point calculation means 3, the interference area extraction means 4, the non-maximum displacement axis modification means 5, the command generation means 19, and the command modification means 20.

The command generation means 19 generates an interpolated motion of every control period of the robot on the basis of the target path output from the non-maximum displacement axis modification means 5. That is, the command generation means 19 generates an interpolated motion command on the basis of the target path output from the non-maximum displacement axis modification means 5. The command modification means 20 is disposed downstream of the command generation means 19. The command modification means 20 modifies at least one of the acceleration and deceleration of the maximum displacement axis, the time of start of acceleration or deceleration (hereinafter referred to simply as acceleration-deceleration start time) of the maximum displacement axis, the acceleration and deceleration of the non-maximum displacement axis, and the acceleration-deceleration start time of the non-maximum displacement axis, each during the interpolated motion of every control period of the robot. The command modification means 20 then outputs a motion command.

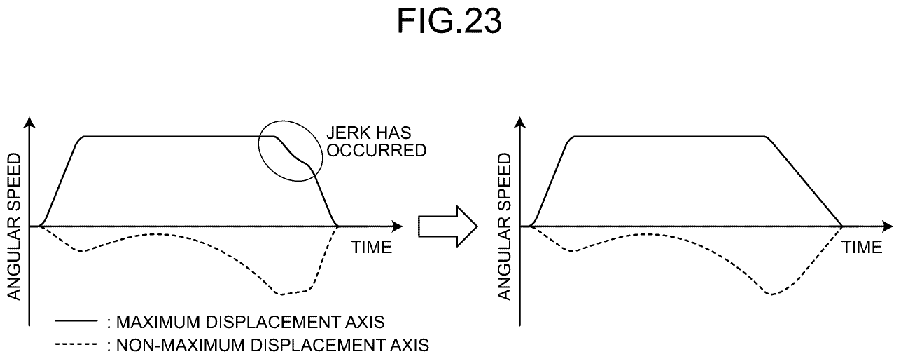

When the command generation means 19 generates an interpolated motion command of every control period of the robot to cause the motion end times of all the axes to synchronize with one another in terms of the target path output by the non-maximum displacement axis modification means 5, synchronization with the motion of the non-maximum displacement axis for avoiding interference may reduce the speed of the maximum displacement axis. FIG. 23 is a diagram illustrating an example of modification on acceleration and deceleration performed by the command modification means 20 included in the path generation device 1F according to the fourteenth embodiment. As illustrated in the left diagram of FIG. 23, when the non-maximum displacement axis needs to avoid interference in the latter half of a series of motions, one cycle of which terminates in a stopped state having an angular speed of zero, starting a speed reduction with a maximum deceleration that can be provided by the maximum displacement axis generates a recess in the speed waveform, i.e., a jerk. To address this, reduction in the deceleration of the maximum displacement axis enables the maximum displacement axis to maintain a speed waveform of a trapezoidal shape as illustrated in the right diagram of FIG. 23. This enables the path generation device 1F according to the fourteenth embodiment to prevent occurrence of an unwanted jerk, and to thus extend the life of components of the robot.

Although FIG. 23 illustrates an example of modification on only deceleration of the maximum displacement axis, the command modification means 20 may optimize a combination of the acceleration and deceleration of the maximum displacement axis, the acceleration-deceleration start time of the maximum displacement axis, the acceleration and deceleration of the non-maximum displacement axis, and the acceleration-deceleration start time of the non-maximum displacement axis, as a combination of acceleration-deceleration parameters that enables reduction of the motion time. Examples of usable technique for combination optimization include particle swarm optimization and Bayesian optimization. In addition, the command modification means 20 may have functionality to verify, for a candidate for the optimum combination of acceleration-deceleration parameters, that the robot activated by a motion command generated using that combination of parameters will interfere with no obstacle, through simulation.

The non-maximum displacement axis modification means 5 in the fourteenth embodiment may be the non-maximum displacement axis modification means 5 of any one of the first through seventh embodiments.

### Fifteenth Embodiment

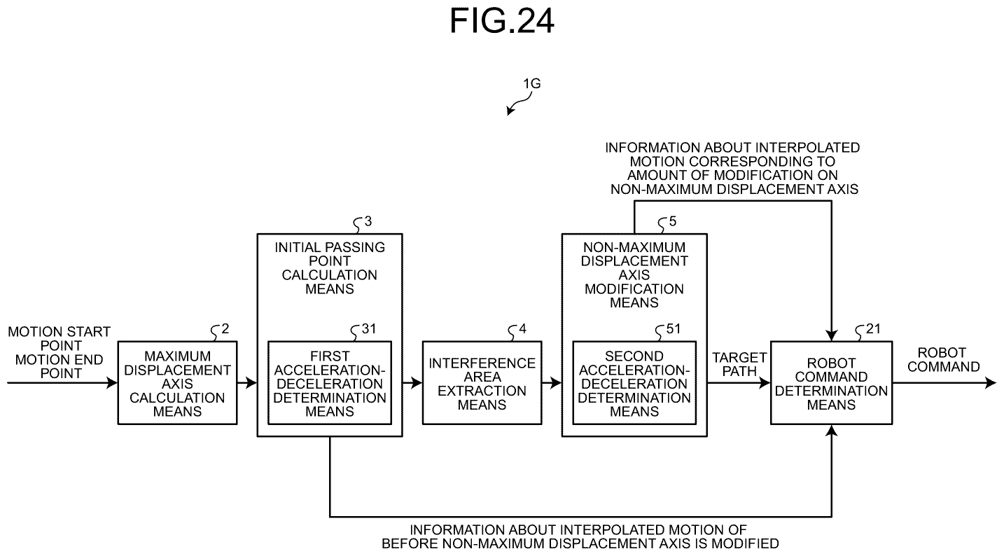

FIG. 24 is a diagram illustrating a configuration of a path generation device 1G according to a fifteenth embodiment. The path generation device 1G includes all the components included in the path generation device 1 according to the first embodiment and robot command determination means 21. That is, the path generation device 1G includes the maximum displacement axis calculation means 2, the initial passing point calculation means 3, the interference area extraction means 4, the non-maximum displacement axis modification means 5, and the robot command determination means 21. The robot command determination means 21 converts, into a robot command, an interpolated motion for a point sequence calculated by the initial passing point calculation means 3 and an interpolated motion for a point sequence corresponding to the amount of modification calculated by the non-maximum displacement axis modification means 5, and outputs the robot command. A point sequence is a sequence of one or more passing points generated by the path generation device, sequentially arranged from the motion start point to the motion end point.

In the fifteenth embodiment, the initial passing point calculation means 3 includes first acceleration-deceleration determination means 31, which determines an acceleration-deceleration parameter of the path determined by the initial passing point calculation means 3, as information about the interpolated motion of before the non-maximum displacement axis is modified. The first acceleration-deceleration determination means 31 outputs the acceleration-deceleration parameter determined, to the robot command determination means 21. The first acceleration-deceleration determination means 31 may be disposed downstream of the initial passing point calculation means 3. The non-maximum displacement axis modification means 5 includes second acceleration-deceleration determination means 51, which determines an acceleration-deceleration parameter of the path generated by modification performed by the non-maximum displacement axis modification means 5, as information about the interpolated motion corresponding to the amount of modification on the non-maximum displacement axis. The second acceleration-deceleration determination means 51 outputs the acceleration-deceleration parameter determined, to the robot command determination means 21. The second acceleration-deceleration determination means 51 corresponds to the acceleration-deceleration time calculation means 12 included in the path generation device according to the sixth embodiment. The second acceleration-deceleration determination means 51 may be disposed downstream of the non-maximum displacement axis modification means 5. When the second acceleration-deceleration determination means 51 is disposed downstream of the non-maximum displacement axis modification means 5, the non-maximum displacement axis modification means 5 outputs a resultant path obtained by combining the path based on the operation of the initial passing point calculation means 3 and the path obtained by modification performed by the non-maximum displacement axis modification means 5. In this case, the second acceleration-deceleration determination means 51 restores the path to the path before combining to obtain the acceleration-deceleration parameter for the modified path.

In general, an industrial robot controller is provided with motion commands written by a specialized programming language. Examples of such motion commands include a command for interpolating two specified points in a joint coordinate system, and a command for interpolating two specified points by linear interpolation. A command for interpolating two specified points in a joint coordinate system is hereinafter referred to as MOV command, and a command for interpolating two specified points by linear interpolation is hereinafter referred to as MVS command.

Determining the acceleration-deceleration parameter and providing an MOV command or an MVS command to the command generation means, or determining the acceleration-deceleration parameter immediately before a robot control device executes an MOV command or an MVS command causes an interpolated motion command of every control period of a robot to be generated. Considering that determination of the acceleration-deceleration parameter by the robot control device may cause the actual path to be deflected from the target path output from the non-maximum displacement axis modification means 5, the following description assumes that the path generation device 1G performs operation including the determination of the acceleration-deceleration parameters.

To convert an interpolated motion into a robot command after determination of the acceleration-deceleration parameters, the first acceleration-deceleration determination means 31 needs to determine the acceleration-deceleration parameter of the interpolated motion for the point sequence calculated by the initial passing point calculation means 3, and the second acceleration-deceleration determination means 51 needs to determine the acceleration-deceleration parameter of the interpolated motion for the point sequence corresponding to the amount of modification calculated by the non-maximum displacement axis modification means 5 to avoid interference. The acceleration-deceleration parameter of the interpolated motion for the point sequence corresponding to the amount of modification calculated by the non-maximum displacement axis modification means 5 can be determined by, for example, the calculation performed by the acceleration-and-deceleration-considered modification means 8 described in the sixth embodiment. The acceleration-deceleration parameter of the interpolated motion for the point sequence calculated by the initial passing point calculation means 3 can also be determined by similar calculation performed by the first acceleration-deceleration determination means 31. The robot command determination means 21 generates a motion command for the robot, corresponding to the output of the initial passing point calculation means 3 and a motion command for the robot, corresponding to the modified motion corresponding to the amount of modification calculated by the non-maximum displacement axis modification means 5, on the basis of information about the point sequence calculated by the initial passing point calculation means 3, information about the point sequence corresponding to the amount of modification calculated by the non-maximum displacement axis modification means 5, and the acceleration-deceleration parameters calculated by the first acceleration-deceleration determination means 31 and by the second acceleration-deceleration determination means 51.

Although the case has heretofore been described where the path generation device 1G according to the fifteenth embodiment performs operation including the determination of the acceleration-deceleration parameters, the acceleration-deceleration parameter may be determined outside the path generation device 1G. When the acceleration-deceleration parameter is determined outside the path generation device 1G, the path generation device 1G does not need to include the first acceleration-deceleration determination means 31 and the second acceleration-deceleration determination means 51. In this case, the robot command determination means 21 generates the motion command for the robot, corresponding to the output of the initial passing point calculation means 3, and the motion command for the robot, corresponding to the modified motion based on the amount of modification calculated by the non-maximum displacement axis modification means 5, on the basis of information about the point sequence calculated by the initial passing point calculation means 3 and information about the point sequence corresponding to the amount of modification calculated by the non-maximum displacement axis modification means 5.

As described above, the path generation device 1G according to the fifteenth embodiment converts the target path generated in the operation through to the non-maximum displacement axis modification means 5 into multiple interpolated motion commands, and outputs these commands. This eliminates the need for the robot controller to store path point sequences, thereby enabling reduction in the storage capacity of the robot controller.

The initial passing point calculation means 3 in the fifteenth embodiment except for the first acceleration-deceleration determination means 31 is the initial passing point calculation means 3 of the first embodiment. The non-maximum displacement axis modification means 5 in the fifteenth embodiment except for the second acceleration-deceleration determination means 51 may be the non-maximum displacement axis modification means 5 of any one of the first through seventh embodiments.

### Sixteenth Embodiment

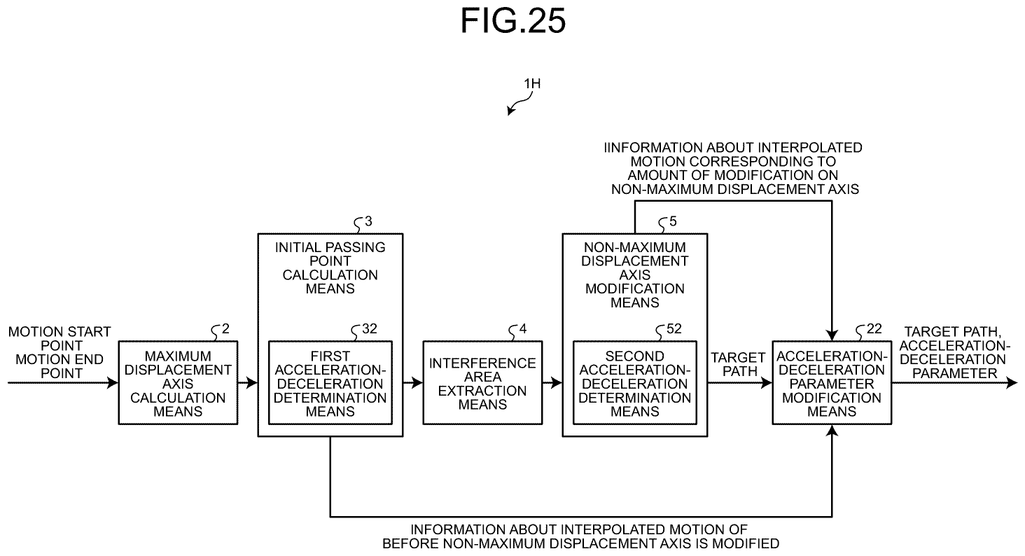

FIG. 25 is a diagram illustrating a configuration of a path generation device 1H according to a sixteenth embodiment. The path generation device 1H includes all the components included in the path generation device 1 according to the first embodiment and acceleration-deceleration parameter modification means 22. That is, the path generation device 1H includes the maximum displacement axis calculation means 2, the initial passing point calculation means 3, the interference area extraction means 4, the non-maximum displacement axis modification means 5, and the acceleration-deceleration parameter modification means 22.

In the sixteenth embodiment, the initial passing point calculation means 3 includes first acceleration-deceleration determination means 32, which determines the acceleration-deceleration parameter of the path determined by the initial passing point calculation means 3, as information about the interpolated motion of before the non-maximum displacement axis is modified. The non-maximum displacement axis modification means 5 includes second acceleration-deceleration determination means 52, which determines the acceleration-deceleration parameter of the path generated by modification performed by the non-maximum displacement axis modification means 5, as information about the interpolated motion corresponding to the amount of modification on the non-maximum displacement axis. The acceleration-deceleration parameter modification means 22 modifies the acceleration-deceleration parameter determined by the first acceleration-deceleration determination means 32 and the acceleration-deceleration parameter determined by the second acceleration-deceleration determination means 52, and outputs a target path and acceleration-deceleration parameters. The path generation device 1H according to the sixteenth embodiment generates the target path using the acceleration-deceleration parameters obtained by modification performed by the acceleration-deceleration parameter modification means 22.

Although the sixteenth embodiment assumes that the first acceleration-deceleration determination means 32 is included in the initial passing point calculation means 3, the first acceleration-deceleration determination means 32 may be disposed downstream of the initial passing point calculation means 3. Although the sixteenth embodiment assumes that the second acceleration-deceleration determination means 52 is included in the non-maximum displacement axis modification means 5, the second acceleration-deceleration determination means 52 may be disposed downstream of the non-maximum displacement axis modification means 5. In combination with the configuration of the fifteenth embodiment, the path generation device 1H according to the sixteenth embodiment may include robot command determination means that converts the target path into a robot command on the basis of the acceleration-deceleration parameters obtained by modification performed by the acceleration-deceleration parameter modification means 22.

As described in the fifteenth embodiment, the acceleration-deceleration parameter of the interpolated motion for the point sequence calculated by the initial passing point calculation means 3 may be not optimal for performing the interpolated motion for the point sequence corresponding to the amount of modification calculated by the non-maximum displacement axis modification means 5 to avoid interference subsequently, in view of conversion of the target path into a robot command for the interpolated motion. For example, when the interpolated motion for the point sequence calculated by the initial passing point calculation means 3 is converted into a first MOV command, and the interpolated motion for the point sequence corresponding to the amount of modification calculated by the non-maximum displacement axis modification means 5 is converted into a second MOV command, determination of the acceleration-deceleration parameter of the first MOV command by the first acceleration-deceleration determination means 32 using up the range of the allowable torque of each axis up to its upper limit before a determination is made of the point sequence corresponding to the amount of modification calculated by the non-maximum displacement axis modification means 5 may result in a small margin of acceleration or deceleration of the robot to be provided for the point sequence corresponding to the amount of modification calculated by the non-maximum displacement axis modification means 5.

Thus, after the point sequence is obtained that corresponds to the amount of modification calculated by the non-maximum displacement axis modification means 5, the acceleration-deceleration parameter modification means 22 modifies the acceleration-deceleration parameter determined by the first acceleration-deceleration determination means 32 and the acceleration-deceleration parameter determined by the second acceleration-deceleration determination means 52 to reduce the total motion time required for the first MOV command and the second MOV command. The acceleration-deceleration parameter modification means 22 modifies the acceleration-deceleration parameters in such a manner that, for example, the acceleration or deceleration of the first MOV command is reduced, and the calculation performed by the acceleration-and-deceleration-considered modification means 8 described in the sixth embodiment is then once more performed. This will enable modification of the acceleration-deceleration parameter of the second MOV command.

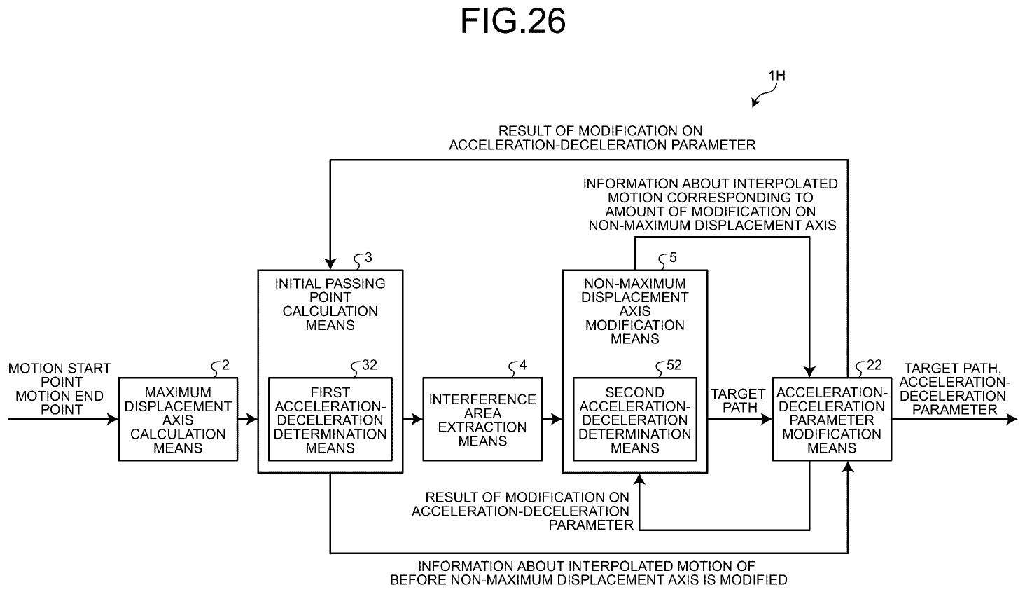

The acceleration-deceleration parameter modification means 22 may use a combinatorial optimization technique such as one described in the fourteenth embodiment to modify the acceleration-deceleration parameter of the first MOV command and the acceleration-deceleration parameter of the second MOV command at one time. In this case, the path generation device 1H according to the sixteenth embodiment can repeat optimization calculation by feeding back results of modification performed by the acceleration-deceleration parameter modification means 22 to the initial passing point calculation means 3 and to the non-maximum displacement axis modification means 5 as illustrated in FIG. 26, and updating the interpolated motion of before the non-maximum displacement axis is modified and the interpolated motion corresponding to the amount of modification on the non-maximum displacement axis. FIG. 26 is a diagram for describing an example of operation of the path generation device 1H according to the sixteenth embodiment.

As described above, the path generation device 1H according to the sixteenth embodiment modifies the acceleration-deceleration parameters to ensure a margin of acceleration or deceleration of the robot in the interpolated motion for the point sequence corresponding to the amount of modification obtained by the non-maximum displacement axis modification means 5 to avoid interference. The path generation device 1H can thus reduce the motion time.

The initial passing point calculation means 3 in the sixteenth embodiment except for the first acceleration-deceleration determination means 32 is the initial passing point calculation means 3 of the first embodiment. The non-maximum displacement axis modification means 5 in the sixteenth embodiment except for the second acceleration-deceleration determination means 52 may be the non-maximum displacement axis modification means 5 of any one of the first through seventh embodiments.

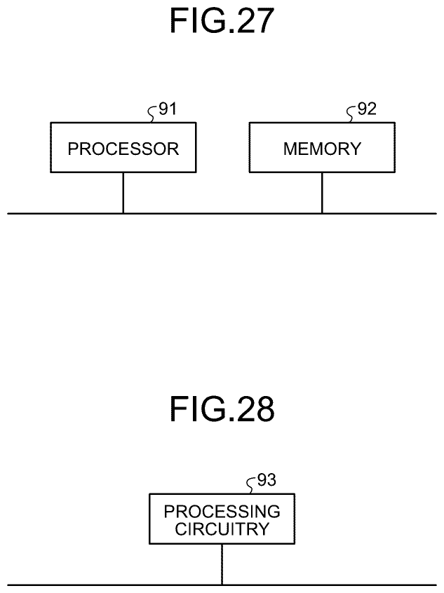

FIG. 27 is a diagram illustrating a processor 91 when at least part of the functionality of the maximum displacement axis calculation means 2, the initial passing point calculation means 3, the interference area extraction means 4, and the non-maximum displacement axis modification means 5 included in the path generation device 1 according to the first embodiment is implemented in the processor 91. That is, at least part of the functionality of the maximum displacement axis calculation means 2, the initial passing point calculation means 3, the interference area extraction means 4, and the non-maximum displacement axis modification means 5 may be implemented in the processor 91, which executes a program stored in a memory 92. The processor 91 is a central processing unit (CPU), a processing system, a computing system, a microprocessor, or a digital signal processor (DSP). FIG. 27 also illustrates the memory 92.

When at least part of the functionality of the maximum displacement axis calculation means 2, the initial passing point calculation means 3, the interference area extraction means 4, and the non-maximum displacement axis modification means 5 is implemented in the processor 91, that part of the functionality is implemented by the processor 91 and software, firmware, or a combination of software and firmware. The software or firmware is described in the form of a program, and is stored in the memory 92. The processor 91 reads and executes a program stored in the memory 92 to provide at least part of the functionality of the maximum displacement axis calculation means 2, the initial passing point calculation means 3, the interference area extraction means 4, and the non-maximum displacement axis modification means 5.

When at least part of the functionality of the maximum displacement axis calculation means 2, the initial passing point calculation means 3, the interference area extraction means 4, and the non-maximum displacement axis modification means 5 is implemented in the processor 91, the path generation device 1 includes the memory 92 for storing a program that causes at least part of steps to be performed, which steps are to be performed by the maximum displacement axis calculation means 2, the initial passing point calculation means 3, the interference area extraction means 4, and the non-maximum displacement axis modification means 5. It can also be said that the program stored in the memory 92 causes a computer to perform at least part of procedures or methods to be performed by the maximum displacement axis calculation means 2, the initial passing point calculation means 3, the interference area extraction means 4, and the non-maximum displacement axis modification means 5.

The memory 92 is, for example, a non-volatile or volatile semiconductor memory such as a random access memory (RAN), a read only memory (ROM), a flash memory, an erasable programmable read only memory (EPROM), or an electrically erasable programmable read-only memory (EEPROM) (registered trademark); a magnetic disk; a flexible disk; an optical disk; a compact disc; a MiniDisc; a digital versatile disk (DVD); or the like.

FIG. 28 is a diagram illustrating a processing circuitry 93 when at least part of the maximum displacement axis calculation means 2, the initial passing point calculation means 3, the interference area extraction means 4, and the non-maximum displacement axis modification means 5 included in the path generation device 1 according to the first embodiment is implemented in the processing circuitry 93. That is, at least part of the maximum displacement axis calculation means 2, the initial passing point calculation means 3, the interference area extraction means 4, and the non-maximum displacement axis modification means 5 may be implemented in the processing circuitry 93.

The processing circuitry 93 is a dedicated hardware element. The processing circuitry 93 is, for example, a single circuit, a set of multiple circuits, a programmed processor, a parallel programmed processor, an application specific integrated circuit (ASIC), a field-programmable gate array (FPGA), or a combination thereof.

A part of the maximum displacement axis calculation means 2, the initial passing point calculation means 3, the interference area extraction means 4, and the non-maximum displacement axis modification means 5 may be implemented in a dedicated hardware element separate from a dedicated hardware element for the remaining part.

Multiple functionalities of the maximum displacement axis calculation means 2, the initial passing point calculation means 3, the interference area extraction means 4, and the non-maximum displacement axis modification means 5 may be implemented in such a manner that part of these multiple functionalities are implemented in software or firmware, and the remaining part of these multiple functionalities are implemented in a dedicated hardware element. As described above, the multiple functionalities of the maximum displacement axis calculation means 2, the initial passing point calculation means 3, the interference area extraction means 4, and the non-maximum displacement axis modification means 5 can be implemented in hardware, software, firmware, or a combination thereof.

The functionality of the non-maximum displacement axis modification means 5 of each of the second through sixth embodiments, the eleventh embodiment, the fifteenth embodiment, and the sixteenth embodiment may be implemented in a processor that executes a program stored in a memory. That memory is a memory similar to the memory 92. That processor is a processor similar to the processor 91. The non-maximum displacement axis modification means 5 of each of the second through sixth embodiments may be implemented in a processing circuitry. That processing circuitry is a processing circuitry similar to the processing circuitry 93.

The functionality of each of the motion segmentation determination means 13 of the seventh embodiment, the linear interpolation insertion determination means 14 of the eighth embodiment, the connection condition calculation means 15 of the ninth embodiment, the effect-of-control-system consideration means 16 of the tenth embodiment, the constraint satisfaction determination means 18 of the thirteenth embodiment, the command generation means 19 of the fourteenth embodiment, the command modification means 20 of the fourteenth embodiment, the robot command determination means 21 of the fifteenth embodiment, the first acceleration-deceleration determination means 31 of the fifteenth embodiment, the second acceleration-deceleration determination means 51 of the fifteenth embodiment, the acceleration-deceleration parameter modification means 22 of the sixteenth embodiment, the first acceleration-deceleration determination means 32 of the sixteenth embodiment, and the second acceleration-deceleration determination means 52 of the sixteenth embodiment may be implemented in a processor that executes a program stored in a memory. That memory is a memory similar to the memory 92. That processor is a processor similar to the processor 91. Each of the motion segmentation determination means 13, the linear interpolation insertion determination means 14, the connection condition calculation means 15, the effect-of-control-system consideration means 16, the constraint satisfaction determination means 18, the command generation means 19, the command modification means 20, the robot command determination means 21, the first acceleration-deceleration determination means 31, the second acceleration-deceleration determination means 51, the acceleration-deceleration parameter modification means 22, the first acceleration-deceleration determination means 32, and the second acceleration-deceleration determination means 52 may be implemented in a processing circuitry. That processing circuitry is a processing circuitry similar to the processing circuitry 93.

The configurations described in the foregoing embodiments are merely examples. These configurations may be combined with another known technology, and configurations of different embodiments may be combined together. Moreover, part of such configurations may be omitted or modified without departing from the spirit thereof.

### REFERENCE SIGNS LIST

1, 1A, 1B, 1C, 1D, 1E, 1F, 1G, 1H path generation device; 2 maximum displacement axis calculation means; 3 initial passing point calculation means; 4 interference area extraction means; 5 non-maximum displacement axis modification means; 6 first passing-point-modification means; 7 second passing-point-modification means; 8 acceleration-and-deceleration-considered modification means; 9 detour direction optimization means; 10 detour point optimization means; 11 detour direction-and-detour point optimization means; 12 acceleration-deceleration time calculation means; 13 motion segmentation determination means; 14 linear interpolation insertion determination means; 15 connection condition calculation means; 16 effect-of-control-system consideration means; 17 constraint storage means; 18 constraint satisfaction determination means; 19 command generation means; 20 command modification means; 21 robot command determination means; 22 acceleration-deceleration parameter modification means; 31, 32 first acceleration-deceleration determination means; 51, 52 second acceleration-deceleration determination means; 91 processor; 92 memory; 93 processing circuitry.

1. A path generation device comprising:
a maximum displacement axis calculating circuitry to calculate a maximum displacement axis among a plurality of axes of a control target, the maximum displacement axis taking a longest time to move in a motion from a motion start point to a motion end point at a prestored maximum speed of a corresponding one of the axes;
an initial passing point calculating circuitry to generate passing points over which the control target passes in a range from the motion start point to the motion end point when the plurality of axes move in synchronization with one another;
an interference area extracting circuitry to extract a section including a passing point on which interference of the control target with a surrounding object will occur, among the plurality of passing points generated by the initial passing point calculating circuitry; and
a non-maximum displacement axis modifying circuitry to generate a passing point that leads to avoidance of the interference, by modifying a position of a non-maximum displacement axis to avoid the interference at the passing point included in the section extracted by the interference area extracting circuitry, the position providing a position of the control target, the non-maximum displacement axis being, among the plurality of axes, an axis other than the maximum displacement axis calculated by the maximum displacement axis calculating circuitry, wherein
the path generation device uses a path that passes over the passing point generated by the non-maximum displacement axis modifying circuitry to avoid the interference, as a target path along which the control target is to pass.

2. The path generation device according to claim 1, wherein
the non-maximum displacement axis modifying circuitry includes
a first passing-point-modifying circuitry to modify a position of the non-maximum displacement axis at a passing point in an interference area, the interference area being the section extracted by the interference area extracting circuitry, and
a second passing-point-modifying circuitry to modify a position of the non-maximum displacement axis before or after the interference area.

3. The path generation device according to claim 1, wherein
the non-maximum displacement axis modifying circuitry includes an acceleration-and-deceleration-considered modifying circuitry to modify the position of the non-maximum displacement axis at a passing point taking into account limitation on acceleration or on torque of each of the plurality of axes.

4. The path generation device according to claim 1, wherein
the non-maximum displacement axis modifying circuitry includes a detour direction optimizing circuitry to optimize a direction for modifying the position of the non-maximum displacement axis to a position where the interference will not occur, on a basis of a time for the control target to move from the motion start point to the motion end point.

5. The path generation device according to claim 1,
wherein the non-maximum displacement axis modifying circuitry includes a detour point optimizing circuitry to optimize a detour point using a moving speed variation of the non-maximum displacement axis and using a torque constraint, the detour point being the passing point that leads to avoidance of the interference.

6. The path generation device according to claim 3, wherein
the non-maximum displacement axis modifying circuitry further includes an acceleration-deceleration time calculating circuitry to calculate acceleration-deceleration times to be used by the acceleration-and-deceleration-considered modifying circuitry to modify a passing point, the acceleration-deceleration times being acceleration-deceleration times of multiple respective ones of the non-maximum displacement axis, when a moving speed of each of the non-maximum displacement axes is varied by modification of the passing point to avoid the interference, the moving speed providing a moving speed of the control target, and
the path generation device modifies the passing point to cause the moving speed of each of the non-maximum displacement axes to vary at a maximum value among the acceleration-deceleration times.

7. The path generation device according to claim 1, further comprising:
a motion segmentation determining circuitry to determine whether the motion of the control target from the motion start point to the motion end point should be segmented, wherein
the path generation device generates a path along which the control target is to move, for each of a plurality of motions generated, and updates the target path when the motion segmentation determining circuitry has determined that the motion should be segmented.

8. The path generation device according to claim 1, further comprising:
a linear interpolation insertion determining circuitry to determine whether the interference should be avoided by linear interpolation for causing the control target to move linearly, wherein
the path generation device performs interference avoidance operation by linear interpolation when the linear interpolation insertion determining circuitry has determined that the interference should be avoided by linear interpolation.

9. The path generation device according to claim 1, further comprising:
a connection condition calculating circuitry to calculate positions of connecting points on a basis of specification of a direction and a magnitude of a target speed at at least one of the motion start point or the motion end point, the connecting points being a start point and an end point of a section in which axes move in synchronization with one another when no interference occurs, wherein
the path generation device generates a path on a basis of the positions of the connecting points calculated by the connection condition calculating circuitry.

10. The path generation device according to claim 1, further comprising:
an effect-of-control-system considering circuitry to estimate an effect of deflection of a course of the control target from the target path, wherein
the path generation device modifies a parameter with respect to an obstacle on a basis of an output from the effect-of-control-system considering circuitry, the parameter being stored in the interference area extracting circuitry.

11. The path generation device according to claim 1, wherein
the non-maximum displacement axis modifying circuitry modifies the position of the non-maximum displacement axis under a constraint based on kinematics of an articulated robot.

12. The path generation device according to claim 1, further comprising:
a command generating circuitry to generate an interpolated motion of every control period of a robot on a basis of the target path; and
a command modifying circuitry to modify at least one of acceleration and deceleration of the maximum displacement axis, an acceleration-deceleration start time of the maximum displacement axis, acceleration and deceleration of the non-maximum displacement axis, or an acceleration-deceleration start time of the non-maximum displacement axis, each during the interpolated motion.

13. The path generation device according to claim 1, further comprising:
a robot command determining circuitry to convert, into a robot command, an interpolated motion for at least one passing point calculated by the initial passing point calculating circuitry and an interpolated motion for at least one passing point corresponding to an amount of modification performed by the non-maximum displacement axis modifying circuitry.

14. The path generation device according to claim 13, further comprising:
a first acceleration-deceleration determining circuitry to determine an acceleration-deceleration parameter of a path determined by the initial passing point calculating circuitry; and
a second acceleration-deceleration determining circuitry to determine an acceleration-deceleration parameter of a path generated by modification performed by the non-maximum displacement axis modifying circuitry, wherein
the first acceleration-deceleration determining circuitry sends the acceleration-deceleration parameter determined, to the robot command determining circuitry, and
the second acceleration-deceleration determining circuitry sends the acceleration-deceleration parameter determined, to the robot command determining circuitry.

15. The path generation device according to claim 1, comprising:
a first acceleration-deceleration determining circuitry to determine an acceleration-deceleration parameter of a path determined by the initial passing point calculating circuitry;
a second acceleration-deceleration determining circuitry to determine an acceleration-deceleration parameter of a path generated by modification performed by the non-maximum displacement axis modifying circuitry; and
an acceleration-deceleration parameter modifying circuitry to modify the acceleration-deceleration parameter determined by the first acceleration-deceleration determining circuitry and the acceleration-deceleration parameter determined by the second acceleration-deceleration determining circuitry, wherein
the path generation device generates the target path using acceleration-deceleration parameters obtained by modification performed by the acceleration-deceleration parameter modifying circuitry.
